(19) United States
(12) Patent Application Publication
(10) Pub. No.: US 2011/0084506 A1
(43) Pub. Date: Apr. 14, 2011

(54) Locking System with Retractable Hook

(76) Inventors: Calin Roatis, Long Grove, IL (US); William Denison, North Barrington, IL (US)

(21) Appl. No.: 12/906,549

(22) Filed: Oct. 18, 2010

Related U.S. Application Data
(63) Continuation-in-part of application No. 12/827,345, filed on Jun. 30, 2010.
Application No. 12/827,345 is a continuation-in-part of application No. 11/386,928, filed on Mar. 22, 2006.
Application No. 11/386,928 is a continuation-in-part of application No. 10/905,524, filed on Jan. 7, 2005, now abandoned.
Application No. 10/905,524 is a continuation of application No. 10/345,864, filed on Jan. 16, 2003, now Pat. No. 6,874,828.
Application No. 10/345,864 is a continuation of application No. 09/962,508, filed on Sep. 25, 2001, now Pat. No. 6,581,986.
(60) Provisional application No. 60/252,210, filed on Nov. 21, 2000.

(51) Int. Cl. E05B 47/00; E05C 3/12

(52) U.S. Cl. 292/240; 292/195; 292/201; 292/199

(57) ABSTRACT

A locking system and a method for locking and unlocking a door to an opening in a cabinet or the like is disclosed. The locking system includes a latching assembly for attachment to one of either a door or a cabinet. The latching assembly includes a motor, a first driving member operatively coupled to the motor, a second driving member having a pivot and operatively coupled to the first driving member, first and second pivotable plates, each plate having a slidable pivot point and an opening defined therein by an interior edge, a latching plate joining each of the first and second pivotable plates, and at least a first cam element fixed to a first surface of the second driving member about the pivot and positioned within the opening of the first pivotable plate to engage the interior edge. A second cam element may be fixed to a second surface of the second driving member about the pivot and positioned within the opening of the second pivotable plate to engage the interior edge. A receiving post completes the locking system and is attached to the other of the door or the cabinet, the preferred receiving post including a longitudinal axis, and a latching portion.

### RELATED APPLICATIONS

This application is a continuation-in-part of U.S. patent application Ser. No. 12/827,345, filed Jun. 30, 2010, which is a continuation-in-part of U.S. patent application Ser. No. 11/386,928, filed Mar. 22, 2006, which is a continuation-in-part of U.S. patent application Ser. No. 10/905,524, filed Jan. 7, 2005, which is a continuation of U.S. patent application Ser. No. 10/345,864, filed Jan. 16, 2003, now U.S. Pat. No. 6,874,828, incorporated herein by reference, which is a continuation of U.S. patent application Ser. No. 09/962,508, filed Sep. 25, 2001 (now U.S. Pat. No. 6,581,986), incorporated herein by reference, which is based on Disclosure Document No. 453,811, filed Mar. 26, 1999, entitled “Vending Cam Lock,” incorporated herein by reference, and claims priority to U.S. Provisional Patent Application No. 60/252,210, filed Nov. 21, 2000, incorporated herein by reference. This application is also related to, and incorporates by reference, U.S. Pat. No. 6,575,504, filed Sep. 25, 2001, which descends from the aforesaid Provisional application (i.e., U.S. Provisional Patent Application Ser. No. 60/252,210).

### TECHNICAL FIELD OF THE INVENTION

The present invention relates generally to locking devices and, more particularly, to a locking system for vending machines and the like and a method for locking and unlocking the same.

### BACKGROUND OF THE INVENTION

In various vending-type machines, such as food machines, candy machines, refrigerated drink machines, and the like, there is ordinarily provided a lock assembly to prevent unauthorized access to the contents. For example, some vending machines are provided with a key-activated lock assembly, such as a pop-out T-handle lock assembly, which allows an authorized user to open the door of the machine with a properly-encoded key. These T-handle lock assemblies are well-known in the art, as evidenced by numerous patents including U.S. Pat. No. 3,089,330 (Kerr), U.S. Pat. No. 3,550,412 (Pitel et al.), U.S. Pat. No. 4,552,001 (Roop), U.S. Pat. No. 4,760,721 (Steinbach), U.S. Pat. No. 4,899,561 (Myers), and U.S. Pat. No. 5,548,982 (Rawling). With such lock assemblies, the door is initially closed in a loose manner to catch the locking components of the lock assembly. Next, the handle of the locking assembly is rotated to draw the door against the housing of the vending machine and to compress a seal between the door and the housing. More modern vending machines are provided with a keypad-activated lock assembly which permits the door of the vending machine to be opened when a predetermined access code or combination is entered into the keypad. The prior art fails to provide a lock assembly which automatically pulls the door of a vending machine into a completely closed position against the housing and/or a lock assembly which utilizes a remotely controlled electronic latching mechanism to lock and unlock the door. More recently, as shown in U.S. Pat. No. 6,068,305 (Myers et al.), such a locking system was proposed. Further, as thefts and tampering with these machines increases, component refinements and improved locking systems have been sought by users and manufacturers of the machines.

The most commercially accepted electronic locking system marketed by applicants' assignee TriTeq Lock and Security, LLC. is disclosed in U.S. Pat. Nos. 6,874,828, 6,581,986, 6,575,504 and pending application Pub. No. US 2005/0161953. In each of these references a motor driven bayonet locking system has a bayonet locking element that moves both in the translational and rotational axis and co-acts with a stationary slotted plate by extending to enter the plate, rotating to create interference from being withdrawn and then retracting to pull in and lock the door.

Other approaches both prior and later, none of which are believed to have become commercially-acceptable, have sought to employ different types of mechanical latches and only uni-directional action electronic drivers such as solenoids.

U.S. Pat. No. 4,167,104 proposed the use of screw posts going into a threaded opening with a solenoid operating latching bolt. Similarly, U.S. Pat. Nos. 6,867,685 and 6,525,644, both to Stillwagon did the same with a notched post latch.

Publication US 2003/0127866 to Martinez proposes a motor driven rotary hook and u-bolt where the hook shape provides pull in cam action.

Publication No. US 2004/0154363 to Beylotte et al. has sought to motor drive a threaded post into a threaded split nut as in prior mechanically operated T-handle vending machine locks. Beylotte et al. proposed a motor driven cam hook in an alternative embodiment.

U.S. Pat. No. 6,068,308 to Myers et al. is an earlier form of latch with a pull in function.

### SUMMARY OF THE INVENTION

An electro-mechanical cam-operated system having a function that facilitates specialized movements that can be utilized to secure and seal a variety of devices. The sealing action is being defined as a pulling motion of the primary mechanism. The locking action happens by virtue of a localized geometry that interfaces into another specialized designed receiver device. The receiver device is generally mounted in a stationary manner. The localized geometrically designed element is called a cam or a bayonet for the purposes of this abstract. The cam or bayonet design is not intended to be a single geometry element that unto itself is design critical to the operation concept of this mechanism. Alternate methodology may be used to facilitate the securing portion of the mechanism.

The cam is designed to operate perpendicular to the receiver in such a manner as to allow it to enter into the receiver by allowing the cam to have geometry that allows the cam to enter into it. After this is accomplished an electrical detection device sends a signal to an electrical control device. This device then sends a signal to a motor that in turn rotates a cylindrical device located about another cam. This cylindrical device has a unique geometry that interfaces with a central located tube type of device and a tubular type pin. The combined rotation causes the other cam to first rotate 90 degrees or thereabout. And then begin to wind its way up a spiral ramp located in a pocket of the cylindrical device. This cylindrical device also has two binary electrical devices that are strategically located to detect the relative position of the locking cam for both rotation and sealing (pull). This cylindrical device has a typical gear shape located on its outside diameter. This gear movement is derived from a worm gear interface that is driven by a motor. The motor derives its intelligence from the electrical controller.

The bayonet is designed to operate tangent to the receiver in such a manner as to allow it to interlock into the receiver by allowing the bayonet to have geometry that allows the bayonet to enter into and pass behind it. After this is accomplished an electrical detection device sends a signal to an electrical control device. This device then sends a signal to a motor that in turn rotates a cylindrical device located about the bayonet. This cylindrical device has a unique geometry that interfaces with a central located tube type of device and a tubular type pin. The combined rotation causes the bayonet to first rotate 90 degrees or thereabout. And then begin to wind its way up a spiral ramp located in a pocket of the cylindrical device. This cylindrical device also has two binary electrical devices that are strategically located to detect the relative position of the bayonet for both rotation and sealing (pull). This cylindrical device has a typical gear shape located on its outside diameter. This gear movement is derived from a worm gear interface that is driven by a motor. The motor derives its intelligence from the electrical controller.

In another embodiment in accordance with the present invention, an optionally keyless electronically operated bayonet locking device and method of operating the same is provided wherein a rotatable and translatable bayonet device or means having an arrow shaped end is carried by respective ones of the vending machine door and cabinet and a stationary slotted receiving member carried by the other one of the respective door and cabinet. The bayonet device arrow shaped end enters the slotted receiving member and then rotates to secure the door and the end translates longitudinally to pull in the door for effectively sealing a door gasket on the machine. The locking device is constructed so as to enable that rotation at least in the transitional phase with longitudinal translation of the arrow shaped end occurs together.

A specific intelligence is embedded into the controller that facilitates several fault modes and operational parameter of the electromechanical system. This intelligence may be delineated as relay or software type of logic. The lock controller provides two specific functions.

Access control functions to ascertain the authorized user is accessing the locking device. Several access control methodologies may be utilized such as keypads with specific codes for entry, hand-held transceivers, electronic digital keys, transponders, etc.

Typical access control functions such as keypads, remote controls and electronic keys are taught in U.S. Pat. No. 5,618,082 to Denison and U.S. Pat. No. 5,349,345 to Vandershel. The locking device may utilize any such access control methodology that is appropriate for the application for the operator and for the enclosure to which the lock is mounted.

Lock motor control functions once the controller has determined the lock is authorized to change from the locked to unlocked state, or, authorized to change from the unlocked to locked state. The components required to accomplish the required motor control operation are the motor drive, cam or bayonet, Receiver, Receiver Sensor, SW1 end of rotation sensor, SW2 30 degree Sensor, over-current sensor, and the CPU based controller.

The cylindrical device has a cover located about the opposite side of the area that causes the pin to wind it way on the ramp. This cover keeps the pin in a proper perpendicular path to the mechanisms securing motion.

The utilization of this device is providing simple easy access to devices that by necessity of application have a gasket or another means of sealing a door or the like. This would be described by what is common known as an automotive door. The door must be accelerated to a speed that can facilitate the compression of the gasket and then secure the door. Much like slamming of a car door. This device provides an alternate method of closing the door and pulling the gasket to a sealed condition. This device is also furthered in its invention by having methodology through electrical monitoring of the cam or bayonet conditions to adjust the pressure on the door gasket or seal. This is accommodated either by electrical position devices or detecting the motor characteristics by the electrical controller. The automotive door is used to only describe the actions, which caused the necessity of this invention. Any device that has a requirement for securing and sealing is a possible application of this device.

A non-exhaustive listing of possible applications for the present locking system includes truck doors, vending machine doors, automotive doors, refrigerator doors, and the like.

The cylindrical device with its associated motor and electrical detection devices are always mounted in a manner that separates them from the receiver unit. To further clarify this explanation consider the following sample concept, a car door has a rotary type securing device that is generally located in the door that secures its via a mechanical interface with a pin that is located in the frame of the vehicle. The cylindrical device would draw a similarity in its function as the rotary type device. The utility of this is to further the security by sealing the door after closing. Recalling that this device in its improvement into the market does not require massive forces to initiate the function of securing the cam or bayonet. This means that the device the system is mounted to would inherently be subject to less stress and wear, thus extending its life.

While there are mechanisms in the public domain that facilitate total system functionality of the specific motion similar to that being described here. One of the unique attributes of this product design is its ability to absorb very high closing impact forces without subjecting the system or the mechanism it is mounted to any impact damages. This system has shock absorbing devices located within the tube and positioned on the end of the cam or bayonet. Such is this geometry that it does not deter from the adjustment function as an independent local event in the motion of pulling in. The cam or bayonet in this system also serves to assist with alignment of the device it's attached to. By moving from the closed to the secure positions the cam or bayonet has geometry which considers the perpendicularity into its motion and effectively cams it into the perpendicular position.

Also the other commercial systems which have similar motion to securing and sealing do not utilize the unique rotary motion of the cam or bayonet used in this system.

This system replaces many devices in the public domain. Systems such a handles for vending machines. This system is designed to operate within the structure of the device it is securing. Therefore there is not external means by which to attack it. It may operate via an electrical controller that can utilize a variety of communication methods that are commercially available. These include but are not limited to Infrared, Radio frequency, and Switch keylock.

Because this design requires the application of an electrical signal to the motor to activate the system for both securing and opening sequence These activities can be monitored for later data collection. This data collection can be facilitated in many methodologies. This data then can serve the operator or owner for the purposes of detecting what key was used to gain access to the system.

One methodology which is being claimed that is unique to this design is the ability to monitor the data through acquisition of the data with the remote initialization device. Typically known as a key, Key FOB of remote control. While this data collection is not primary to the system function. It acts to enhance the product to the market place

In still another embodiment of the invention, a locking system for locking a door to an opening in a cabinet or the like comprises a latching assembly for attachment to one of either a door or a cabinet. The latching assembly comprises a motor, a first driving member operatively coupled to the motor, a second driving member having a pivot and operatively coupled to the first driving member, first and second pivotable plates, each plate having a slidable pivot point and an opening defined therein by an interior edge, a latching plate joining each of the first and second pivotable plates, and at least a first cam element fixed to a first surface of the second driving member about the pivot and positioned within the opening of the first pivotable plate to engage the interior edge. In a similar embodiment, a second cam element may be fixed to a second surface of the second driving member about the pivot and positioned within the opening of the second pivotable plate to engage the interior edge.

The locking system further comprises a receiving post for attachment to the other of the door or the cabinet, the preferred receiving post including a longitudinal axis, and a latching portion. In operation, the first driving member is rotated by the motor, while the second driving member is rotated by the first driving member. The first and second cam elements move with the second driving member to bias against the interior edge of the respective openings of the first and second pivotable plates. The first and second pivotable plates are moved by the first and second cam elements to either engage the latching plate with or disengage the latching plate from the latching portion of the receiving post. Finally, the receiving post is moved along an axis substantially parallel to the longitudinal axis of the post by a force applied by the latching plate to the latching portion.

As an aspect of an embodiment of the invention, the locking system may also comprise a first position switch for initiating operation of the motor, the first position switch being responsive to one of either the door or the cabinet. Still, a second position switch for discontinuing operation of the motor may be employed, the second position switch being responsive to one of the first pivotable plate, the second pivotable plate, the first cam element, the second cam element, the door, the receiving post, or the cabinet.

In a related method for locking a door to an opening, the method comprises the steps of operating a power train to turn a first driving member, turning a second driving member coupled to the first driving member, moving a latching plate fixed to first and second pivoting plates having corresponding respective slidable pivot points and openings defined thereon, engaging a latching portion of a receiving post having a longitudinal axis with the latching plate, continuing movement of the latching plate, drawing the receiving post in a direction parallel to the longitudinal axis, sensing a position of one of the first driving member, the second driving member, the latching plate, or the receiving post, and discontinuing operation of the power train when a predetermined position is achieved.

It is an aspect of the disclosed method that the latching plate and the receiving post are attached to one of either a door or a cabinet having an opening.

It is a further aspect of the disclosed method to include the steps of sensing a position of the door, and signaling a controller to initiate operation of the power train.

These and other aspects of the invention will be more readily understood by those skilled in the art by a careful reading of the following disclosure, including the appended drawings.

### BRIEF DESCRIPTION OF THE DRAWINGS

FIG. 1 is a perspective view of an illustrative vending type machine A with a door B and cabinet C in a partially open position showing the locking devices;

FIG. 2 is an enlarged perspective view of the system with the door mounted receiver and cabinet mounted cam operating lock;

FIG. 3 is an enlarged perspective view of the receiver and cam operator in a locked position free of the door and cabinet;

FIG. 4 is a plan view of the receiver;

FIGS. 5A and 5B respectively are plan views showing the beginning secure functions for the cam and receiver;

FIGS. 6A and 6B are plan views showing the advancements of the cam into the receiver;

FIGS. 7A and 7B are plan views of the system showing rotational locking and drawing in by the cam;

FIGS. 8A and 8B are plan views showing the cam locking unit in its unlocked position without the receiver;

FIGS. 9A and 9B are plan views like FIGS. 8A and 8B with the receiver;

FIGS. 10A to 10F are perspective views of alternative cam designs useful with the electronic lock;

FIGS. 11 and 12 are flow charts showing respective lock and unlock sequences of operation for the cam locking system;

FIG. 13 is a perspective, partially exploded view of a modified form of a receiver and cam operator; and

FIG. 14 is a plan view partially in section of the operating lock of FIG. 13 in a locked portion

FIG. 15 is a perspective view of an illustrative vending type machine A with a door B, gasket B′ and cabinet C in a closed position and showing a remote controller D;

FIG. 16 is a perspective view of the machine of FIG. 15 with the door opened partially;

FIG. 17 is a perspective view of the machine of FIGS. 15 and 16 with the door opened and showing the locking devices;

FIG. 18 is a perspective view of the bayonet system complete less the receiver unit. Wiring has been deleted to clarify the view. Item 101 is the localized design called a bayonet, it is shown in the secure and pulled in (sealed) position. Item 102 is the cylindrical device with the gear. Item 103 located about its outside diameter. Item 104 is the cover for the cylindrical device. Item 105 is a plate which serves to mount all of the items. The plate generally is part of the device that is to be secured. Item 106 is the electrical detection mount bracket that houses Items 106a (SW 1) and Item 106b (SW 2) Item 107 is the local geometry which detects the position of the cylindrical device. Item 108 is the electrical controller board. Item 109 is the adjuster device that positions the bayonet. Item 110 is the motor that provides the drives the gear assembly. Item 111 is the tube. Item 112 is a snap ring that holds the cylindrical device on the tube assembly.

FIG. 19 is a perspective clarifying the position indicators Item 107 of the cylindrical device.

FIG. 20 is a perspective view of the receiver unit. Item 113 is the receiver plate. Item 114 is the housing of the receiver. Item 115 is a door or moveable plate that the bayonet Item 101 pushes as it is inserted into the receiver. Item 117 which is mounted in Item 116 and fastens to Item 114 then switches state. The controller through wiring Item 120 detects this. Items 118 and 119 serve to mount and bias the door assembly. Area Item 114a is provided as a typical mounting scenario.

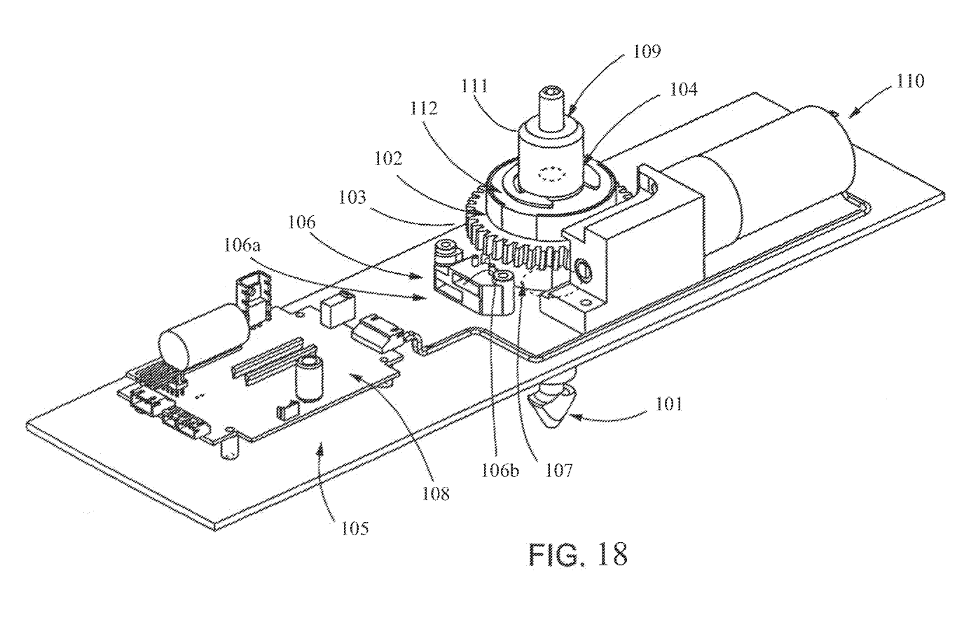

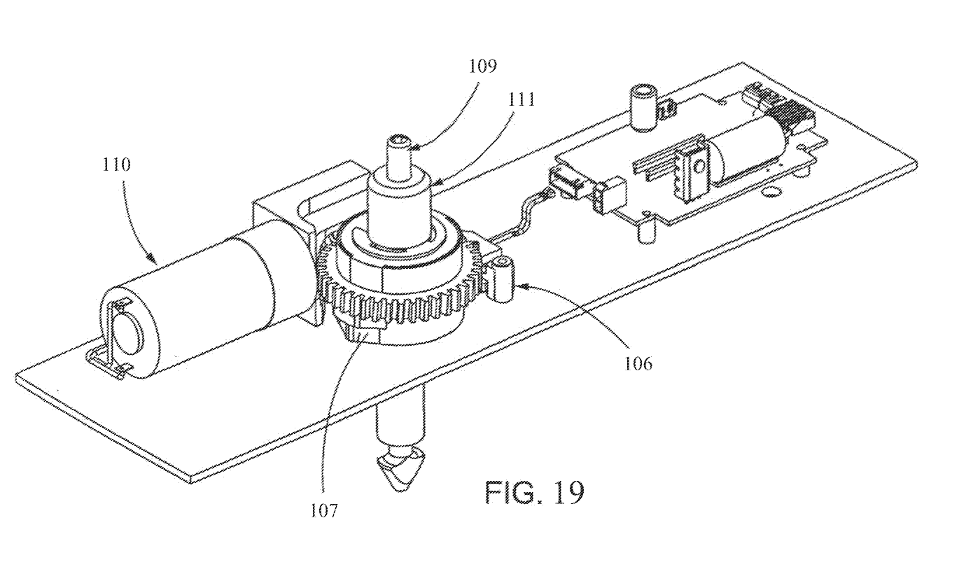

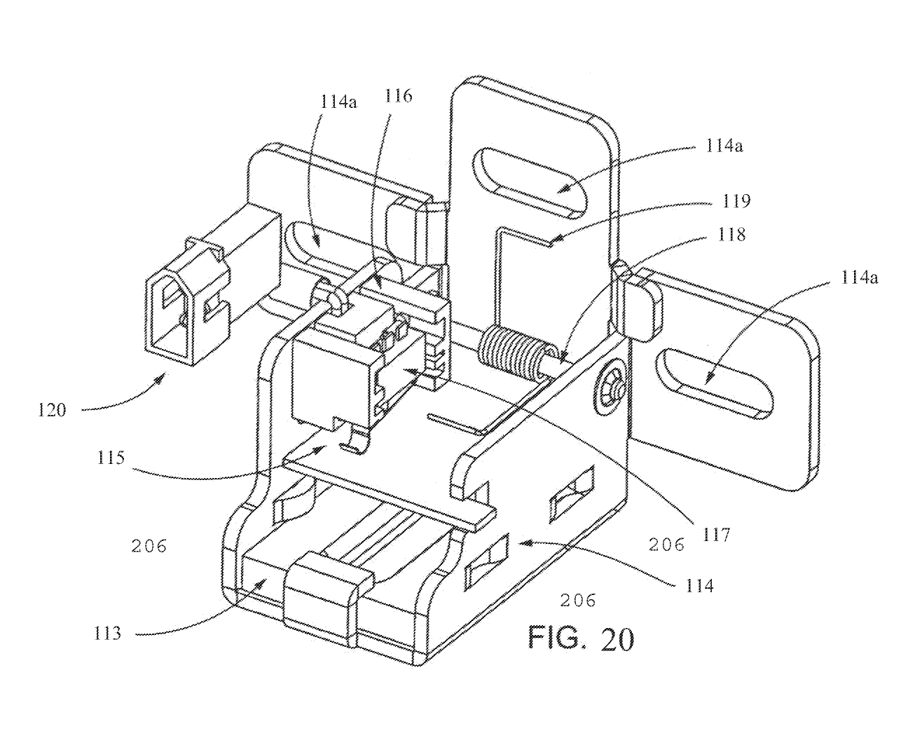

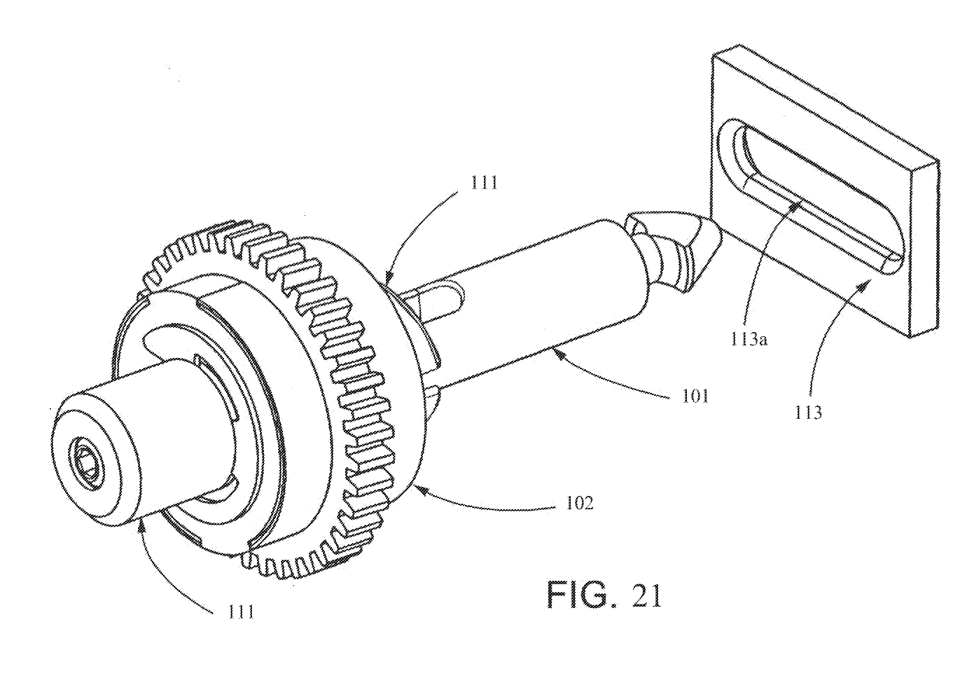

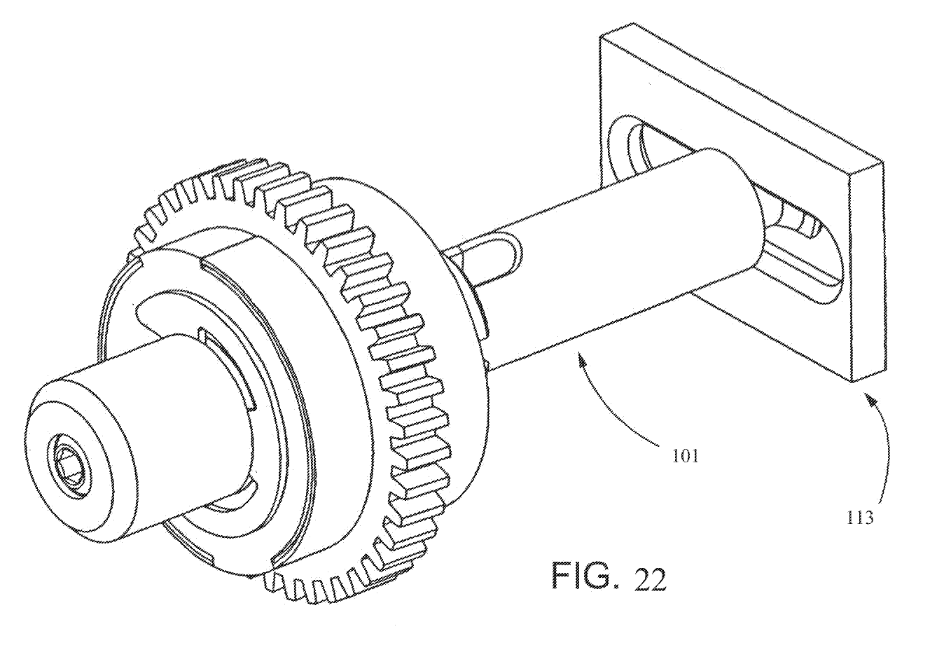

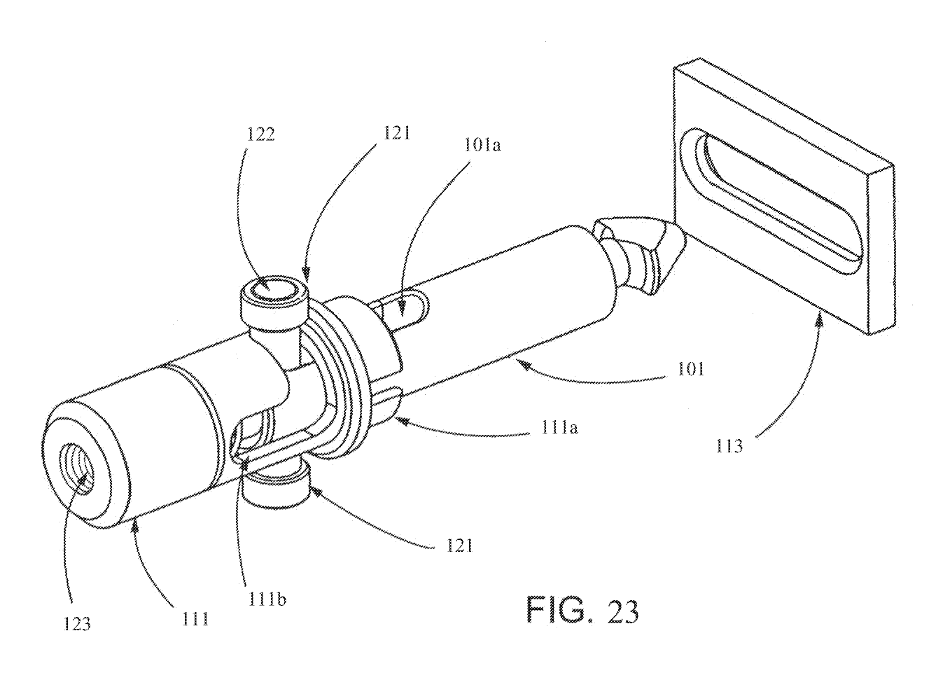

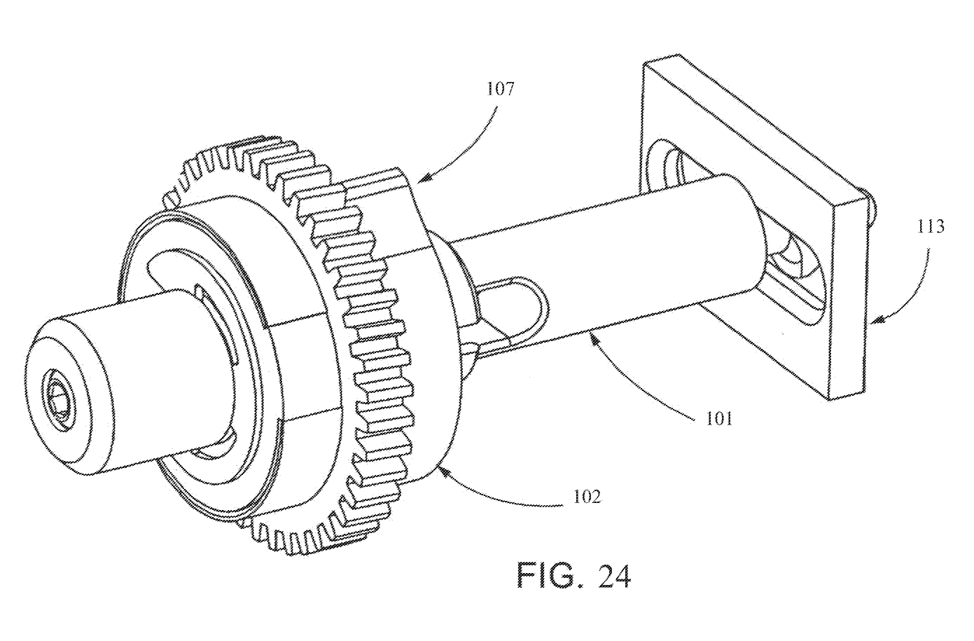

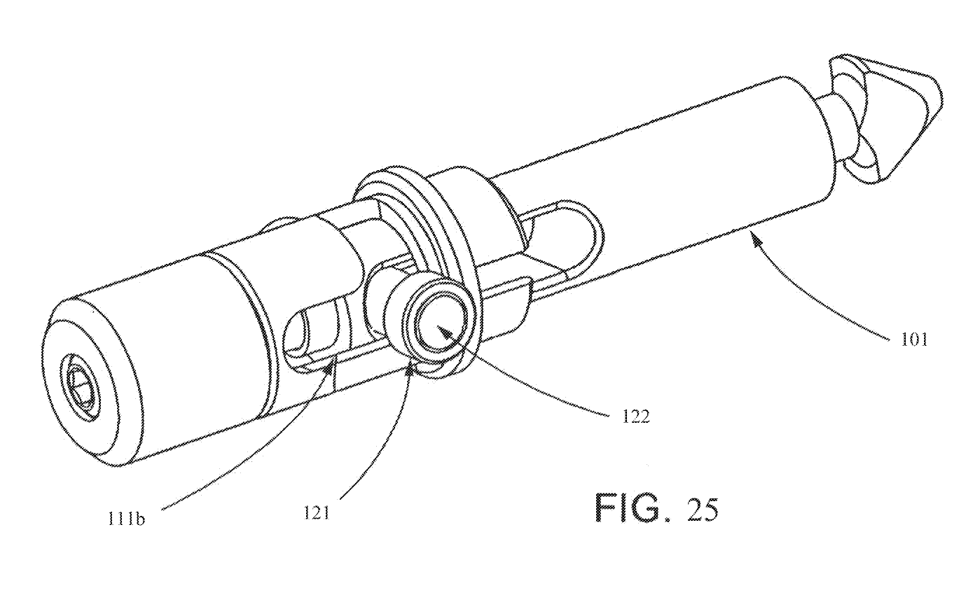

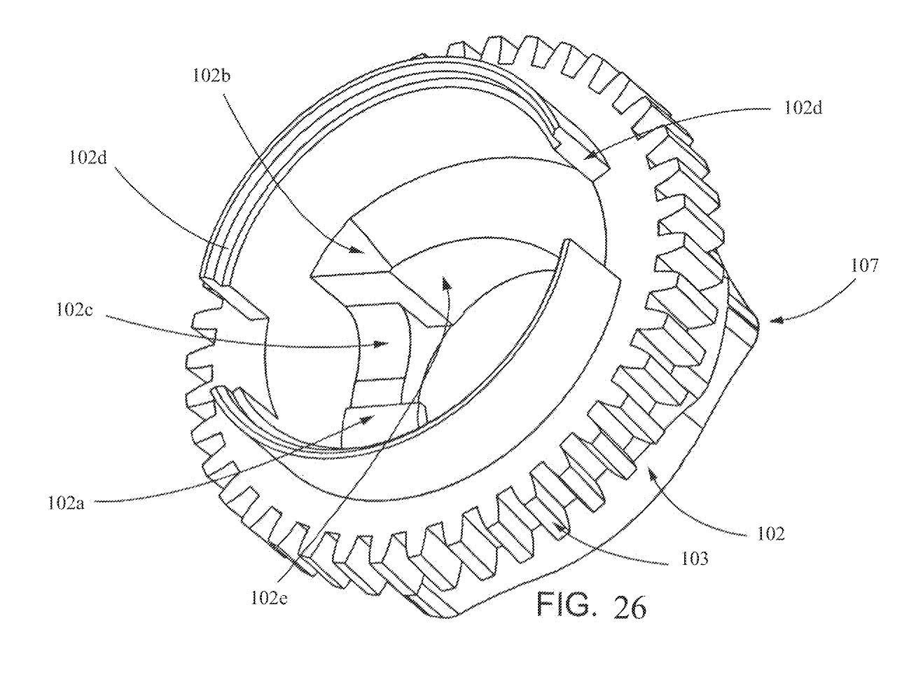

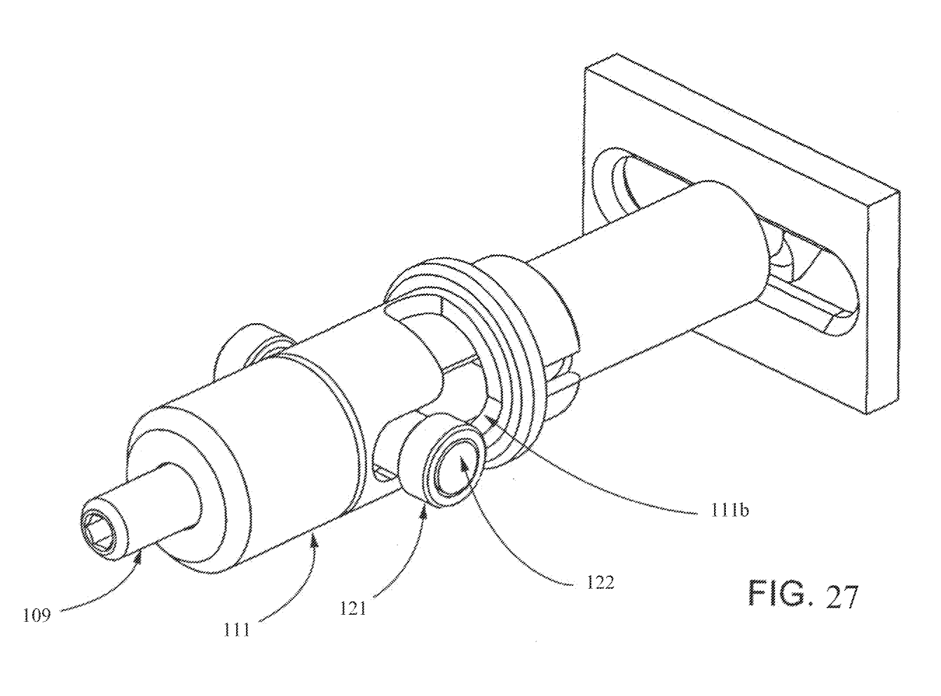

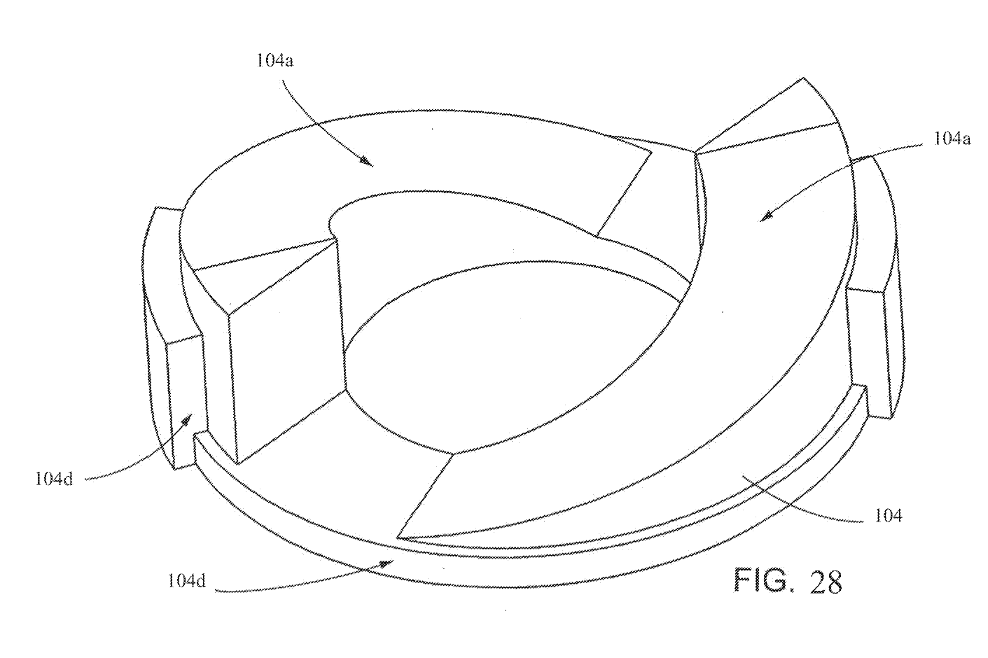

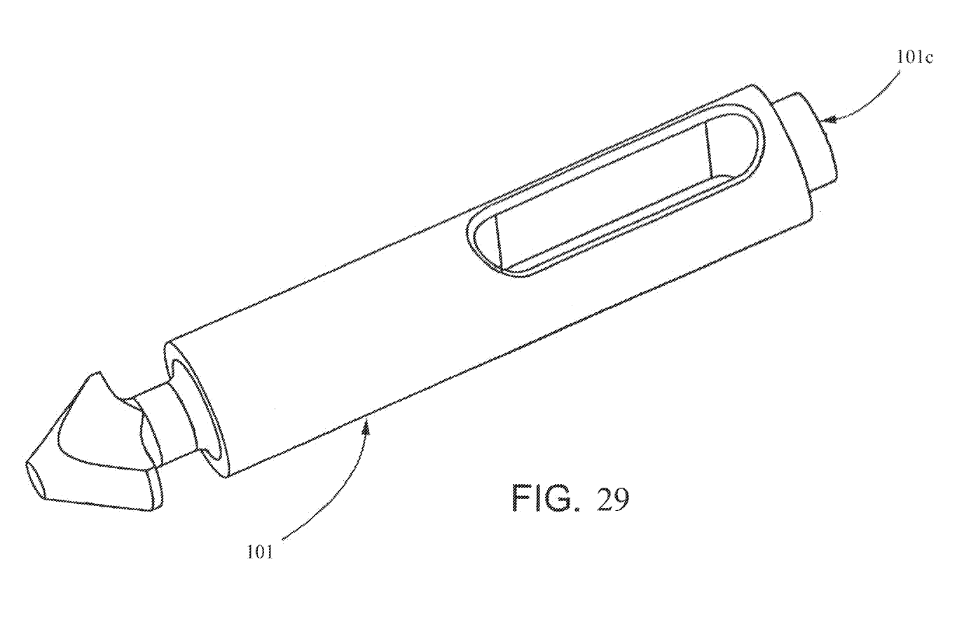

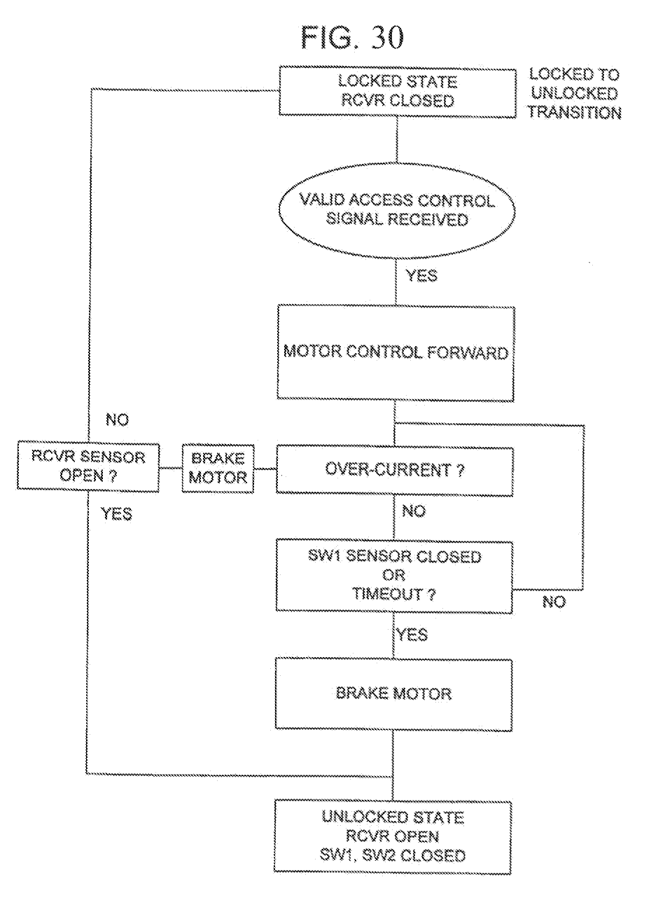

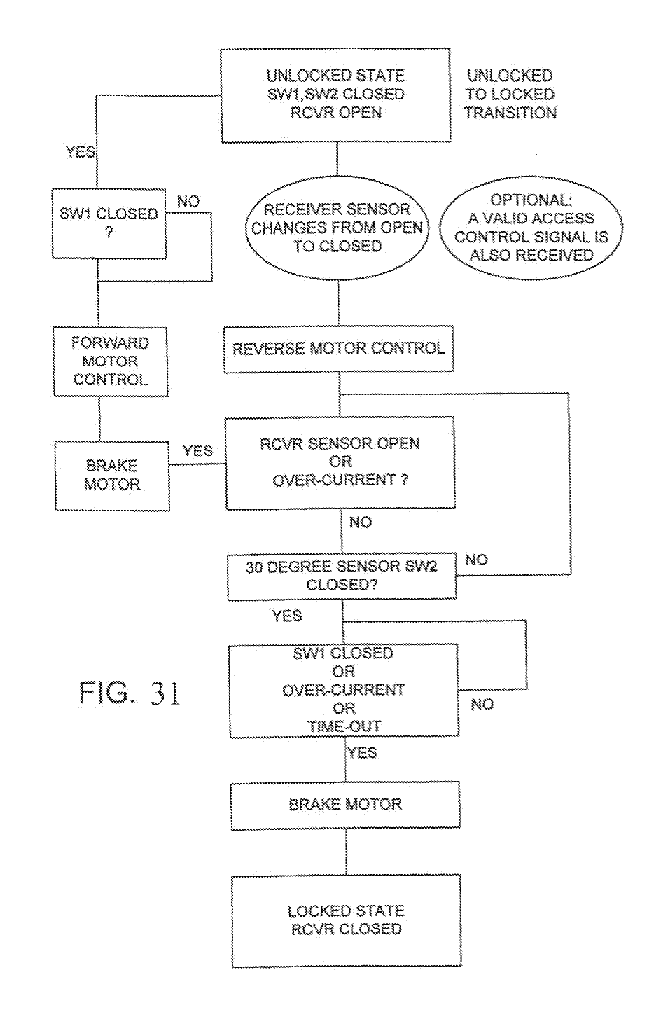

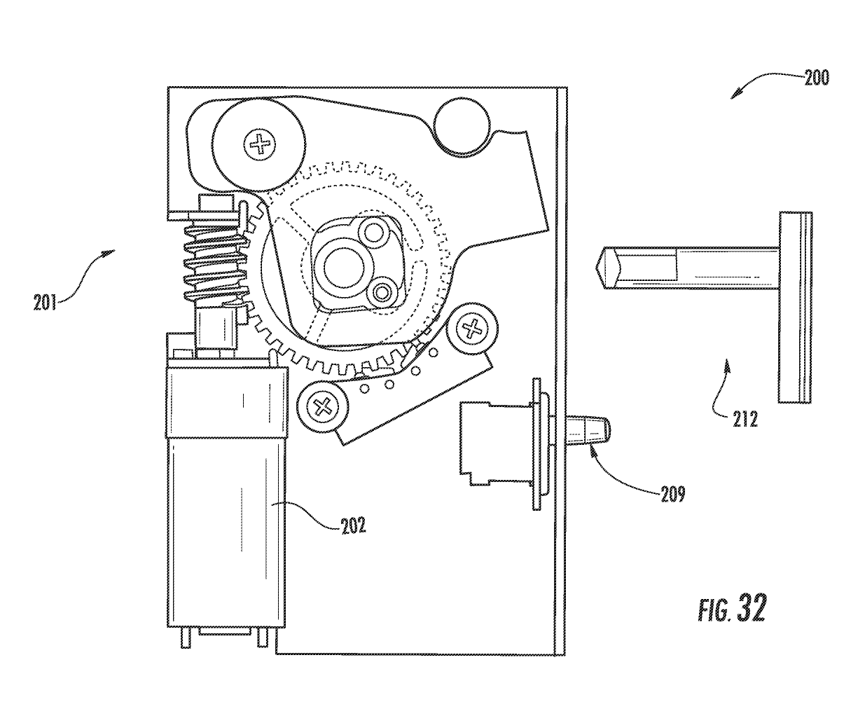

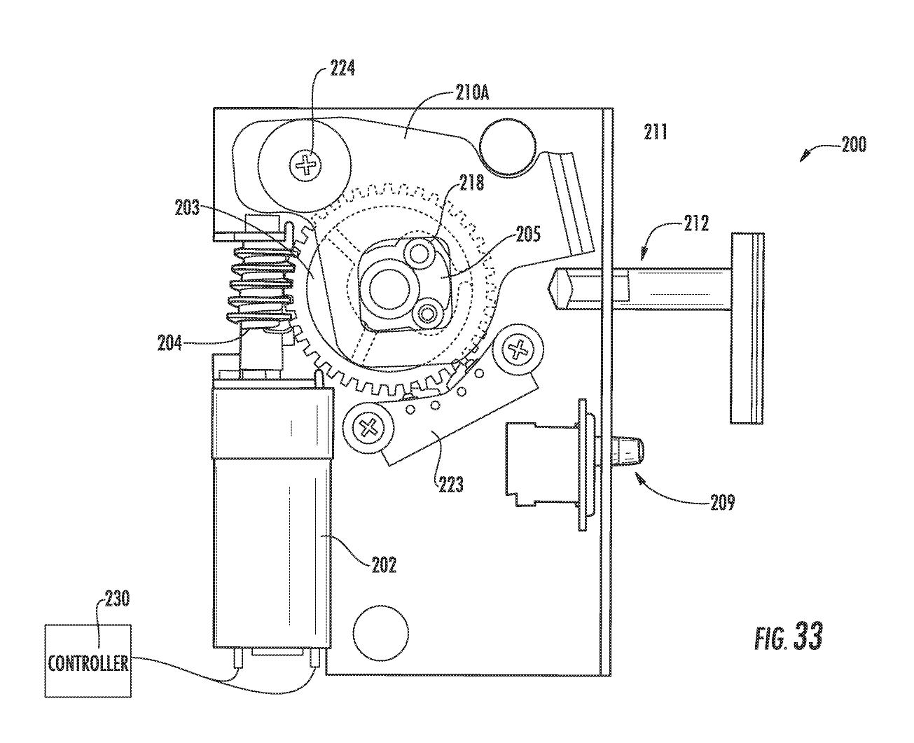

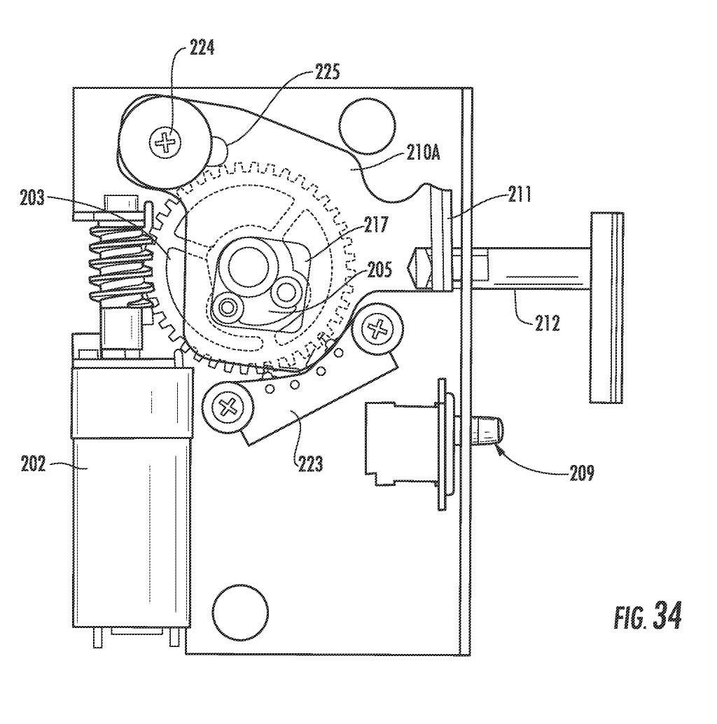

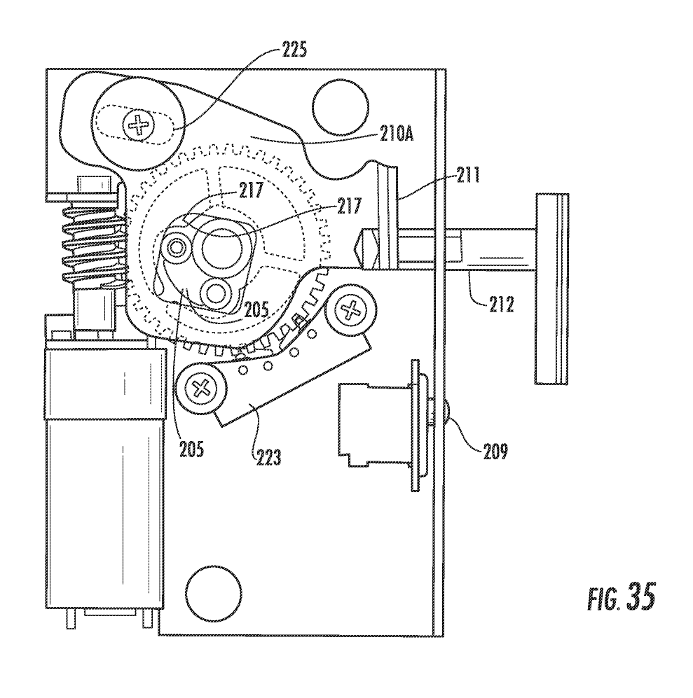

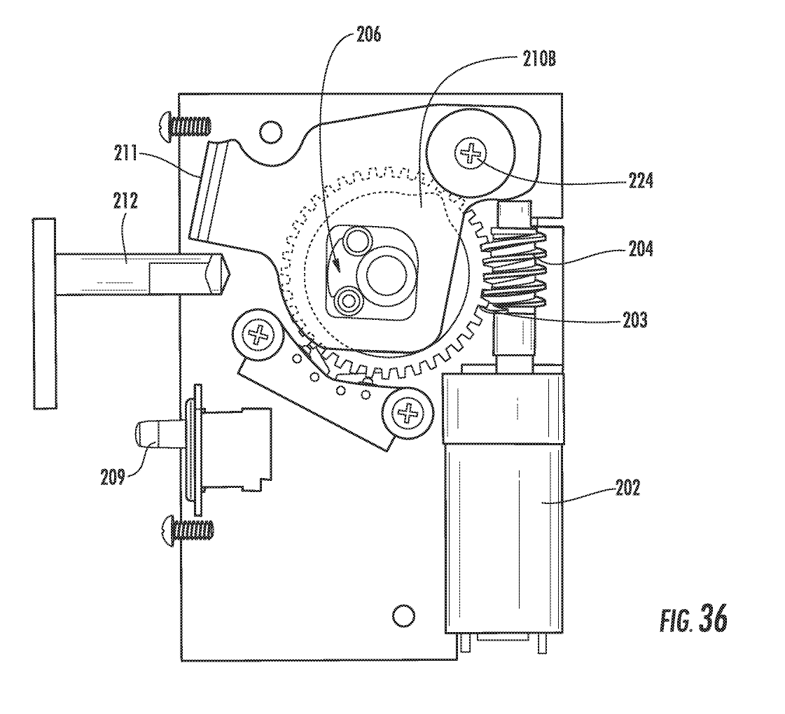

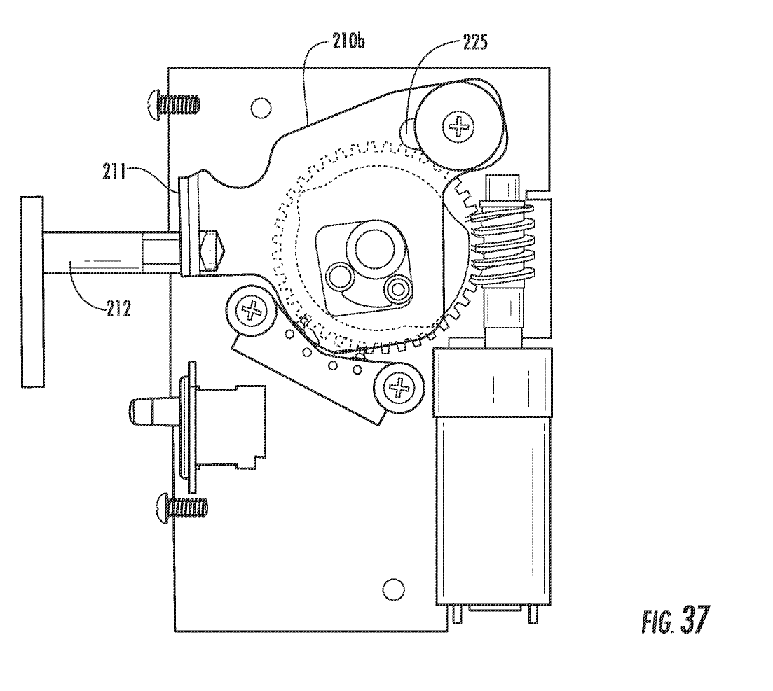

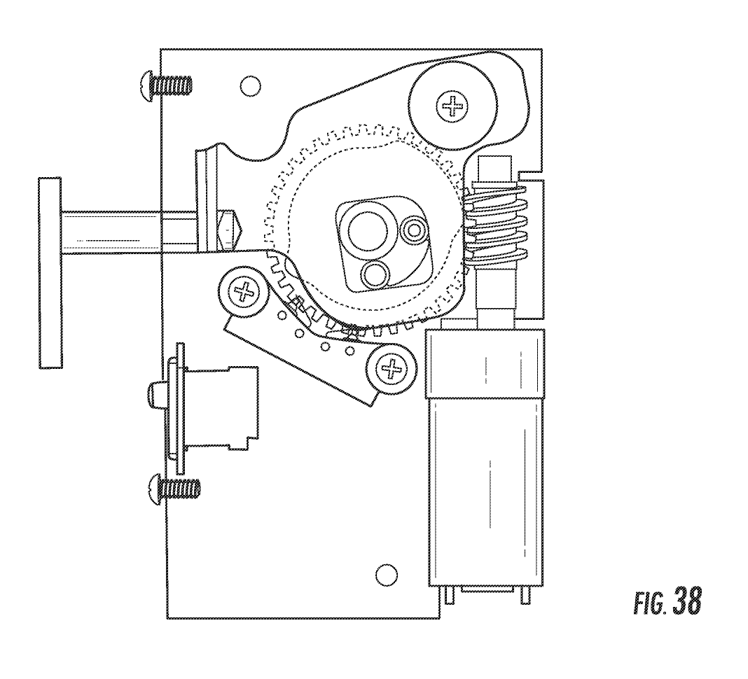

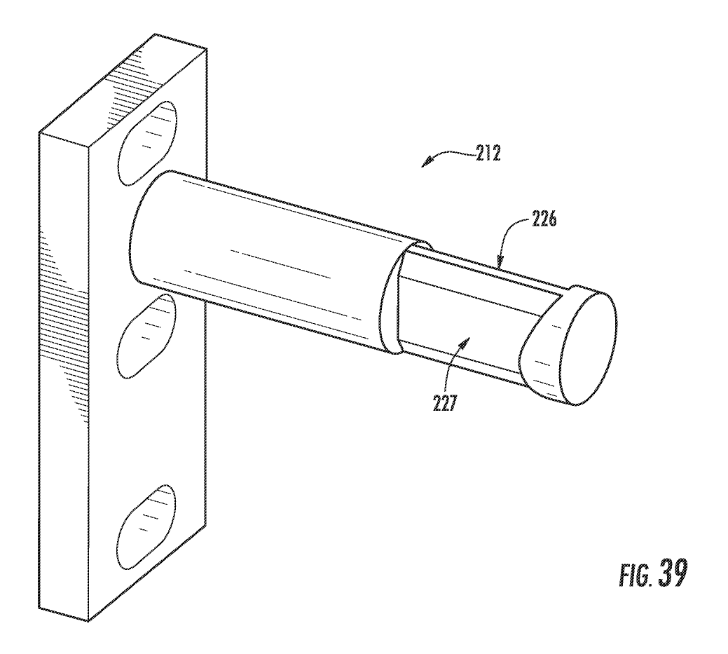

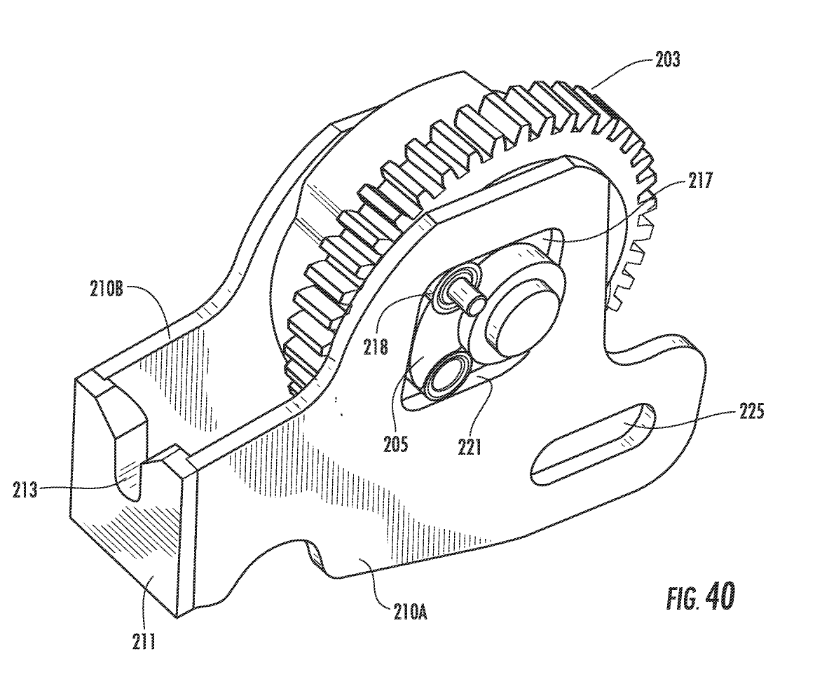

The stationary receiver unit of FIG. 20 is mounted into the stationary cabinet C as shown in FIG. 17 using the holes 114a. The slotted plate 113 receives the end arrow section of the bayonet 101 shown in FIGS. 18 and 19. The moveable plate 115 of FIG. 20 is pushed rearward by the arrow section of the bayonet 101, which causes the movable plate to rotate about the axle 118 and activates the switch 117, resulting in activation of the gear motor 110 shown in FIGS. 18 and 19. A flat spring 206 that is nested in both sides of the receiver unit and having two curved shapes allows the slotted plate 113 to move horizontally in both directions. After the arrow section of the bayonet 101 is removed from the stationary receiver unit, the flat spring will reposition the slotted plate 113 about its original centerline position as it relates to the stationary receiver. This movement allows for horizontal manufacturing tolerance for both the cabinet C and the door B as the lock of FIG. 19 and the stationary receiver of FIG. 20 are mounted. The vertical slot in the slotted plate 113 allows for vertical tolerances.

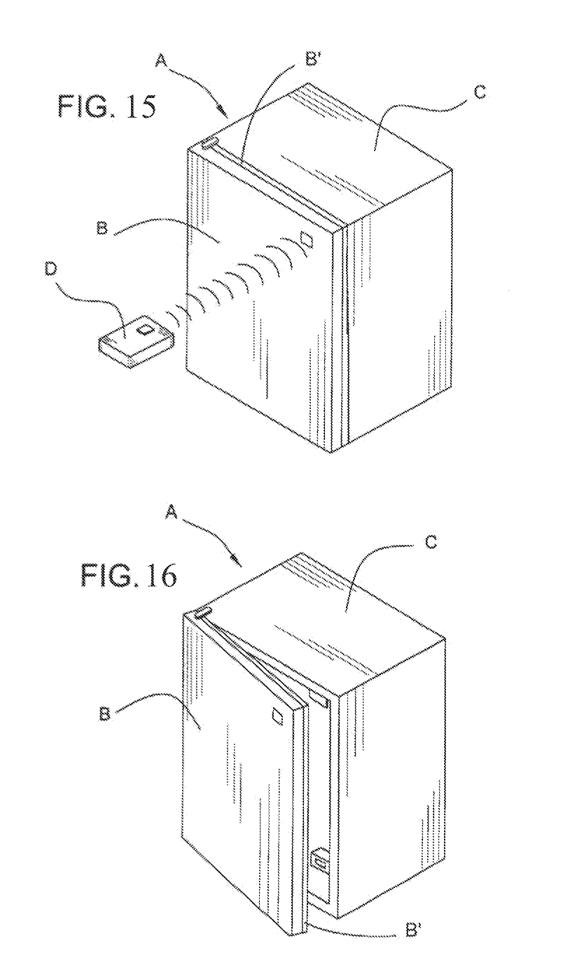

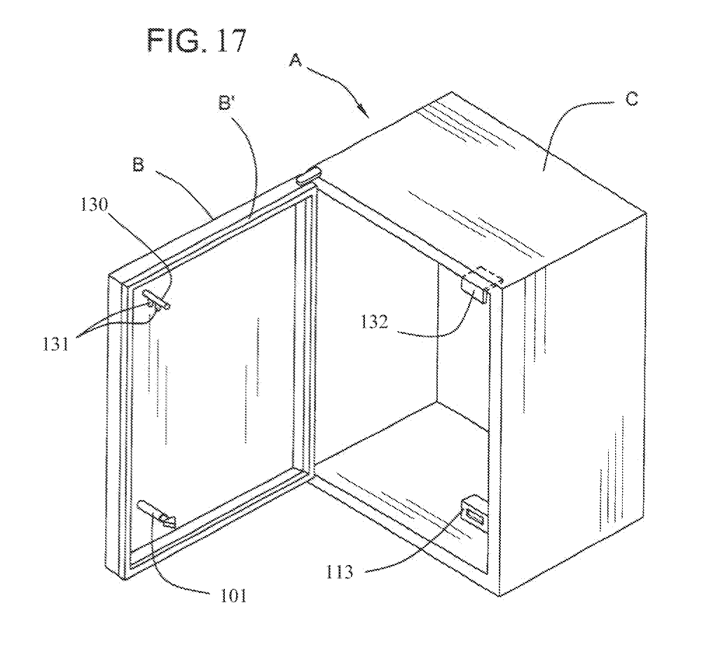

FIGS. 21 and 22 respectively are perspective views of the beginning secure functions. Item 101 is aligned to a slot located in Item 113. Items 111 and 102 move into position (as they are mounted to Item 105) this places the end of the Item 101 behind the Item 113. (FIG. 19). At this time (SW 2) changes state serving as a local detection device. FIG. 15 Item 106b.

FIG. 23 is a perspective view that has Items 102, 112, and 104 removed. Item 111 is kept stationary via slots located in area 111a and with conventional threads. Item 101 has a slot through it to allow a spring action provided by Item 123 as the Item 101 impacts Item 113. The 101a slot provides the area for this. The pin Item 122 is held in place by the geometry 111b. The rollers Items 121 will provide antifriction surfaces during future operations.

FIG. 24 is a perspective view of the bayonet system in its secure position. The Item 102 has rotated and item 106 FIG. 18 (sw1) has detected the proper position via the Item 107 geometry. Item 101 is now located behind Item 113 and is rotated 90 degrees.

FIG. 25 is a perspective view indicating what the internal geometry is in place at the same time as FIG. 21. Pin Item 122 has moved into position along the 111b area. This is accomplished via FIG. 23 area 102a. Gear Item 103 rotates about the area 102e guided by Item 111. Surface 102a causes pin Item 122 to move 90 degrees.

FIG. 26, item 102d is provided as mounting surfaces for FIG. 25 Item 104. Surface 104a as mounted into Item 102 provide guiding for Items 121 and then translated through to Item 122. Area Item 104d corresponds to Item 102d FIG. 23. Area 102a has a steel reinforced arrangement to prevent deformation of the plastic as it ages.

FIG. 27 is a perspective view showing the pulling or sealing function. Item 102 has continued to rotate via the motor Item 110. The local geometry of the ramp area 102a through 102b causes the rollers Items 121 to move with it. This pulls (moves) the Item 101 back away from Item 113. This is seen by the extension of Item 109 as it protrudes from Item 111.

FIG. 28 is a perspective view of the outer guide that mates with the FIG. 23 guide.

FIG. 29 is a perspective view of the bayonet Item 101. Item 101c is threaded to facilitate the adjuster screw Item 109. This screw limits the travel of the Item 101 by intersection of the pin Item 122 with the bottom of the Item 119.

FIGS. 30 and 31 are flow charts showing the respective lock and unlock sequences of operation for the bayonet locking system.

Between Item 102 and mounting plate Item 105 mounting plate there is a thin plate to allow for a sliding friction plate surface this allows for a lubrication area.

FIG. 32 is a side view illustrating an embodiment of a locking assembly as it would be positioned with the door in an open condition;

FIG. 33 is a side view of an embodiment of a locking assembly in an unlocked condition in accordance with the present invention;

FIG. 34 is a similar view of the embodiment of FIG. 32 showing a latched condition of the locking assembly;

FIG. 35 is a similar view of the embodiment of FIG. 32 showing a locked condition of the locking assembly;

FIG. 36 is a side view of the embodiment shown in FIG. 33, though taken from a side opposite to the view of FIG. 33;

FIG. 37 is an opposite side view of the embodiment of the locking assembly shown in FIG. 34 in the latched condition;

FIG. 38 is an opposite side view of the embodiment of the locking assembly shown in FIG. 35 in a locked condition;

FIG. 39 is a perspective view of an embodiment of a receiving post made in accordance with the present invention; and

FIG. 40 is a perspective view of an embodiment of the assembly of a toothed-gear, first and second pivotable plates and the latching plate made in accordance with the present invention.

In consideration of the electrical functions of the system the following description applies to the controller utilized. This controller features unique combination of sensing and control that differentiate it from controllers used in the public domain.

### DETAILED DESCRIPTION OF THE INVENTION

While the present invention is to be described herein in connection with the best mode presently contemplated by the inventor for carrying out the invention, the preferred embodiments described and shown are for purposes of illustration only, and are not to be construed as constituting any limitations of the invention. Modifications will be obvious to those skilled in the art, and all modifications that do not depart from the spirit of the invention are intended to be included within the scope of the appended claims. Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Locked to Unlocked for Both the Cam and Bayonet Locking Systems:

For specific details of the electronic control operation, reference may be made to our co-pending application publication Jul. 28, 2005 as US 2005/0161953 A1. In controlling the motor to change the state of the lock from locked to unlocked, the controller must first receive a valid access control signal from the operator (via a secure access control input means such as a keypad or hand-held transmitter) and shall proceed to energize the motor in the forward direction. The controller will wait for a position feedback indicator which is measured by a controller CPU to determine the lock has landed in the unlocked state. If this sensor is closed, the controller will proceed to break and de-energize the motor. In case the sensor is failed, the controller uses a motor current feedback signal to detect end of worm gear travel by sensing a stall motor condition and to de-energize the motor. In case both sensors fail, the controller will discontinue operation based on elapsed time.

In the case an over-current signal is received, the controller must determine if this signal is a function of a jammed cam with the lock still in the locked state, or if this signal is a function of the worm gear reaching the unlocked state and the sensor failed. In the case of a jam, the receiver sensor is expected to be closed and the condition is still locked. Thus, the controller will proceed to assume a locked condition. In the case the receiver sensor is open, it is assumed that the cam has unseated from the receiver and the lock is unlocked. Thus, the controller will proceed to the unlocked state.

Unlocked to Locked for the Cam Locking System:

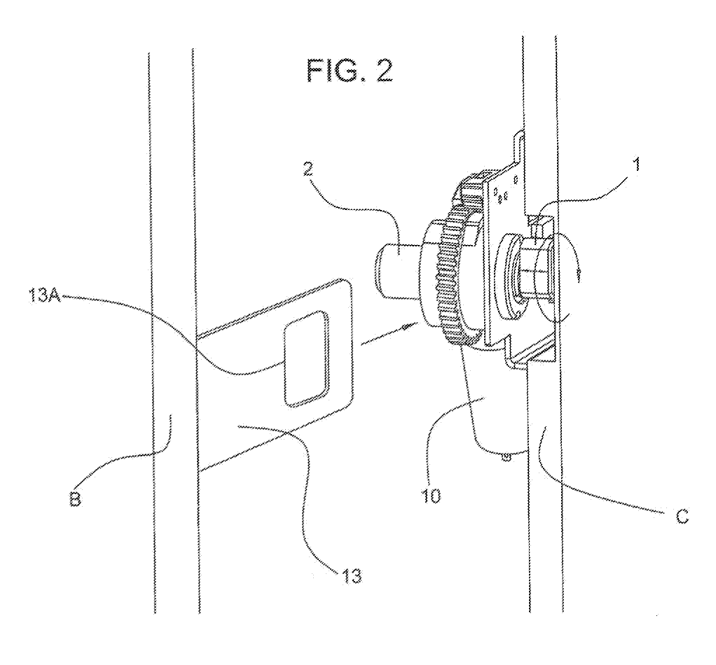

In controlling the motor, FIG. 2, item 10 to change the state of the lock from unlocked to locked, the controller shall wait to receive a valid lock signal from the operator. This signal shall at a minimum be a sensor signal received by the controller whether the cam, FIG. 2, item 1 is positioned to be seated in the receiver.

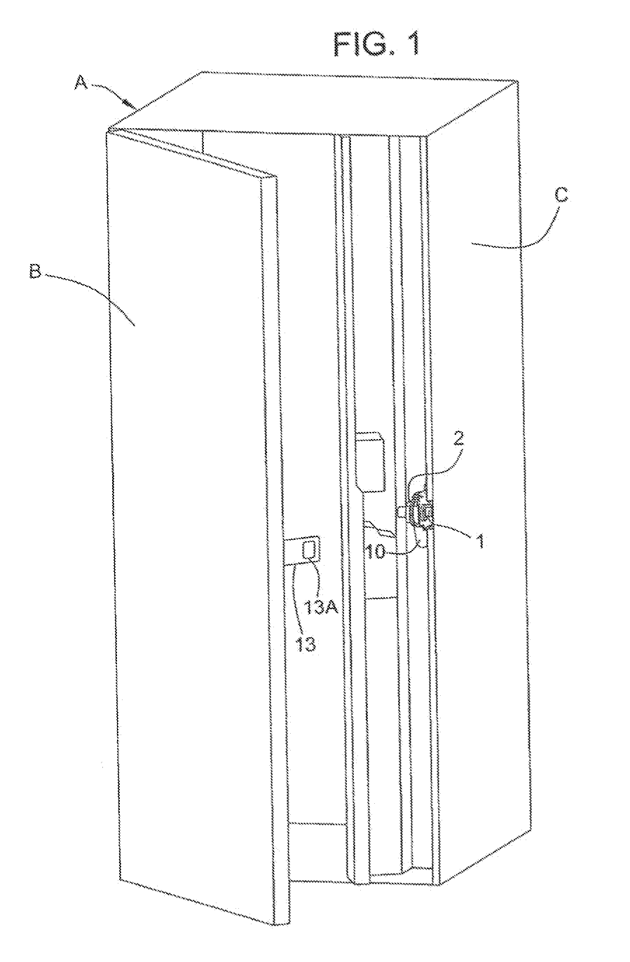

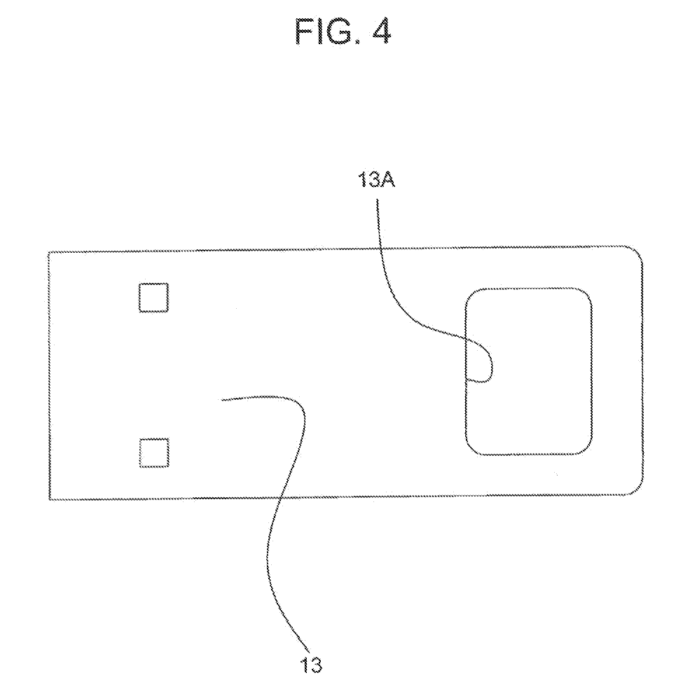

The receiver 13 sensor FIG. 4 is a plate like a member with a slot opening 13A preferably mounted to door B (FIG. 1), which is open when the lock is unlocked

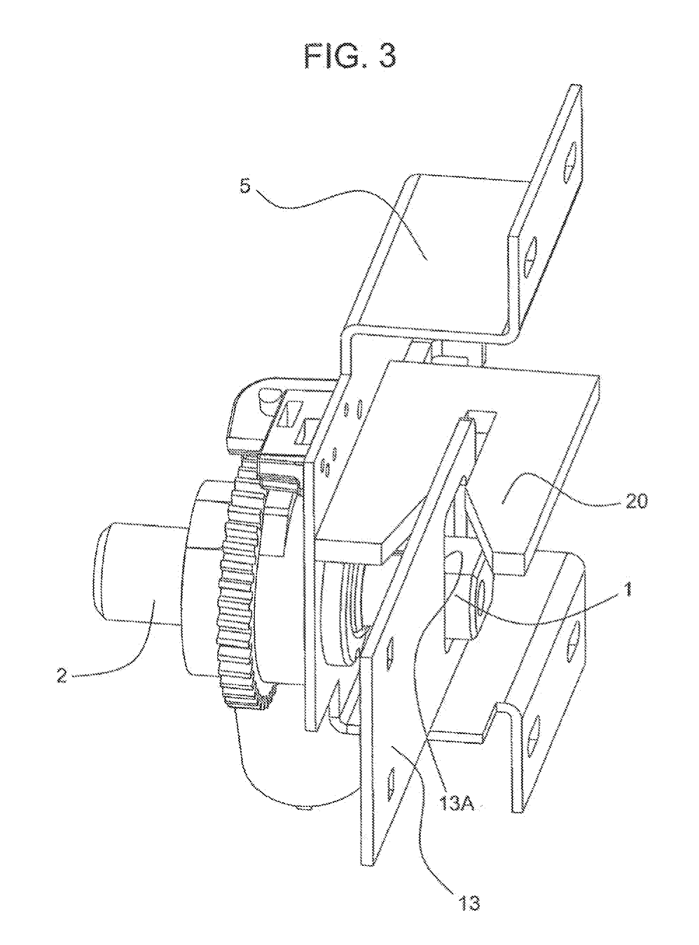

In FIGS. 2 and 3 there is shown the sequence of closing and locking a vending machine door in accordance with the present electronic cam lock system, Door B carrying the receiver 13 with slot opening 13A is moved toward the cabinet C which here carries the cylinder driven unit 2 which operates the cam element 1. In FIG. 3, the plate receiver is guided in place by a Y slot guide 20, the motor drive advances the cam 1 into the slot 13A and the unit 2 is ready for rotation of the cam 1.

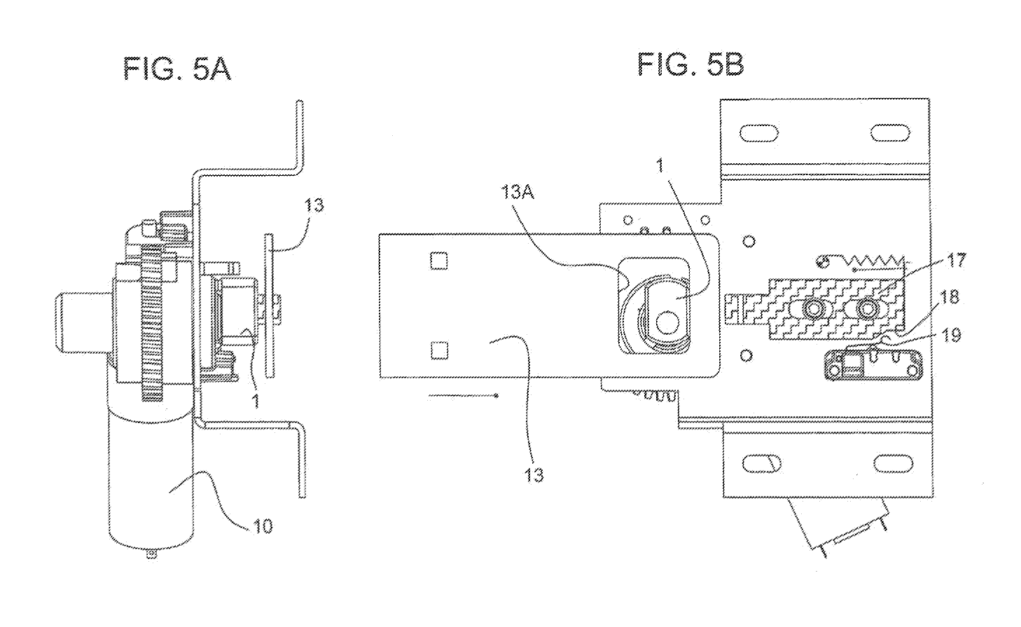

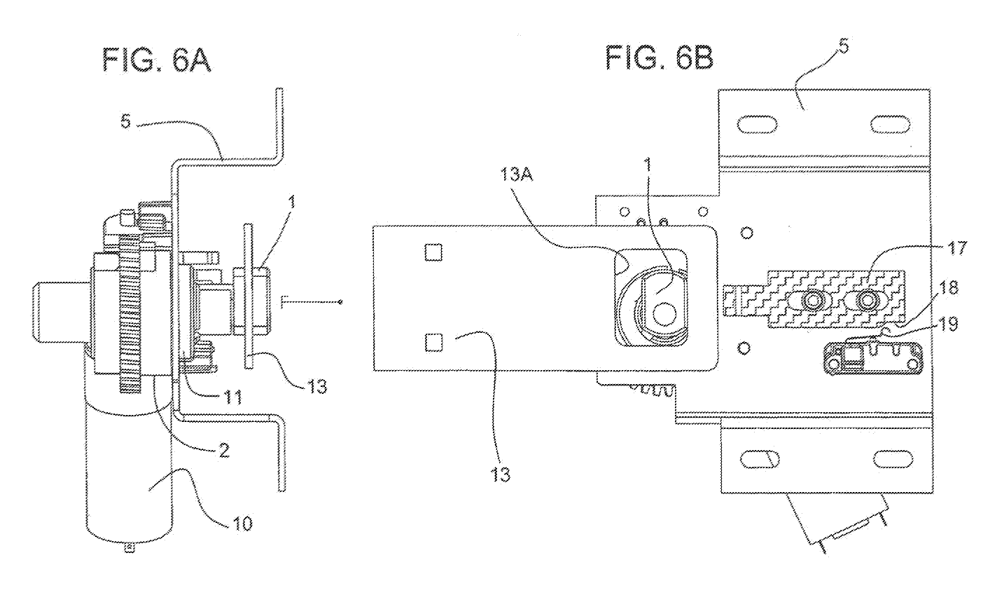

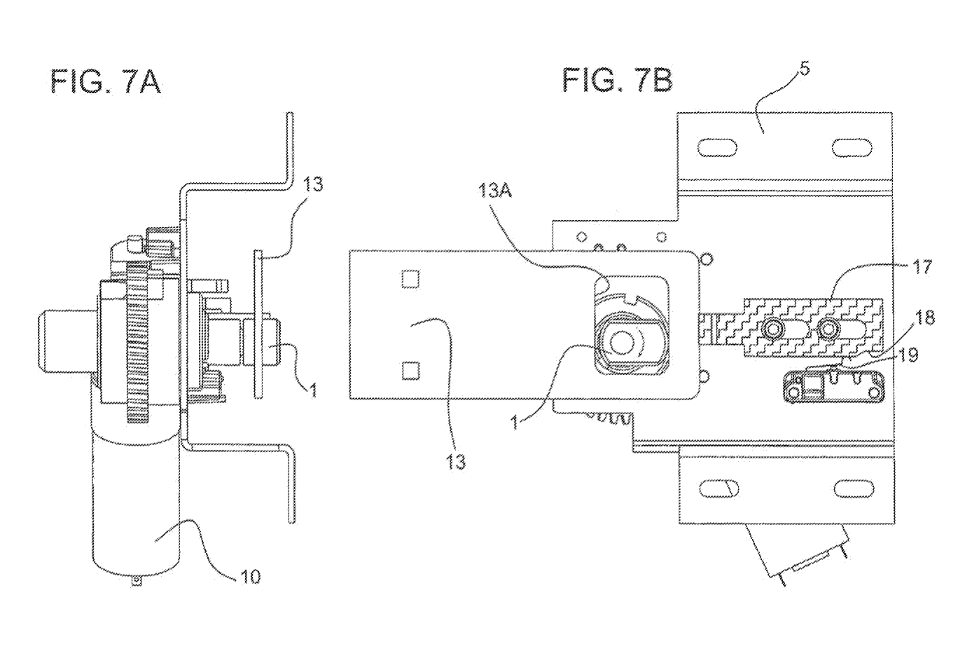

As seen in FIGS. 5A and 5B, the receiver 13 will engage a spring held side 17 that can be moved horizontally to sense the positioning of the receiver with respect to the retracted or unlock position of the cam 1. The slide 17 has a sloped notch area 18 which operates sensor switch 19 to provide the signals for when the locking and unlocking actions can be operated by a controller and the motor drive unit. When the cam 1 is in position and the sensor switch allows the motor drive to operate, FIGS. 5A and 5B, the cam 1 is advanced longitudinally as shown in FIGS. 6A and 6B so that receiver 13 is captured and the door is held closed. Referring to FIGS. 7A and 7B the cam 1 is rotated within slot 13A and the result is that a door carrying receiver 13 would be pulled in. The drive motor 10 rotates the cam 1 in the receiver and pulls in the door until the sensor signals the cam position for the controller to stop the motor. During locking if switch 19 senses that the receiver has moved back out of position before the cam 1 enters the slot the motor is reversed and the unlock position is maintained until the next cycle.

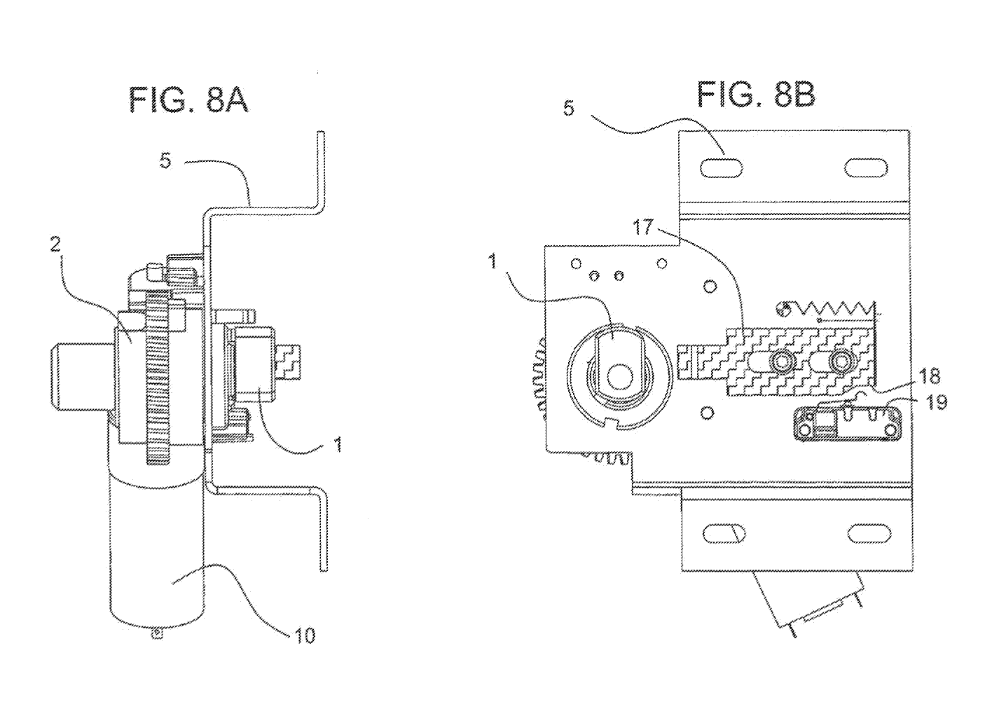

In FIGS. 8A and 8B, the cam 1 driving unit 2 and its components are shown as mounted to a bracket 5 which is easily attachable to a cabinet as in FIGS. 1 and 2. The cam element 1 is shown in a retracted and unlocked position.

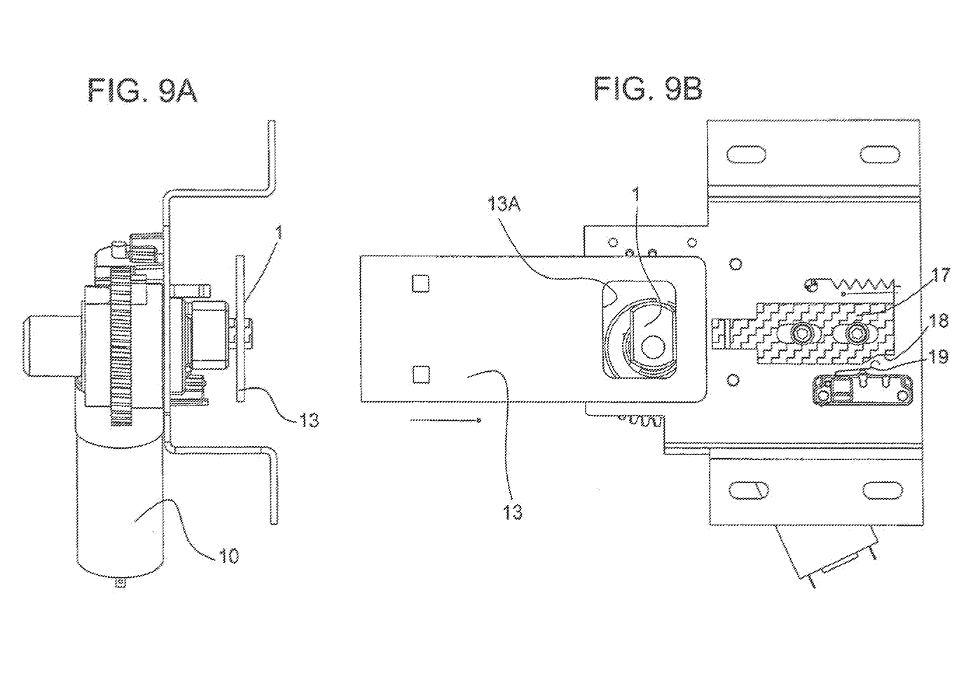

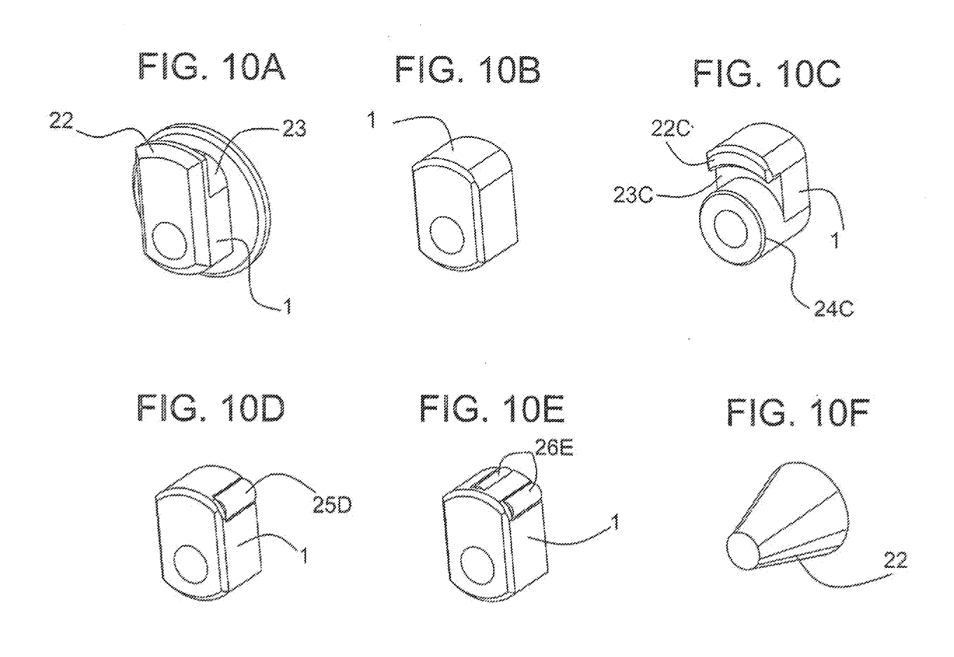

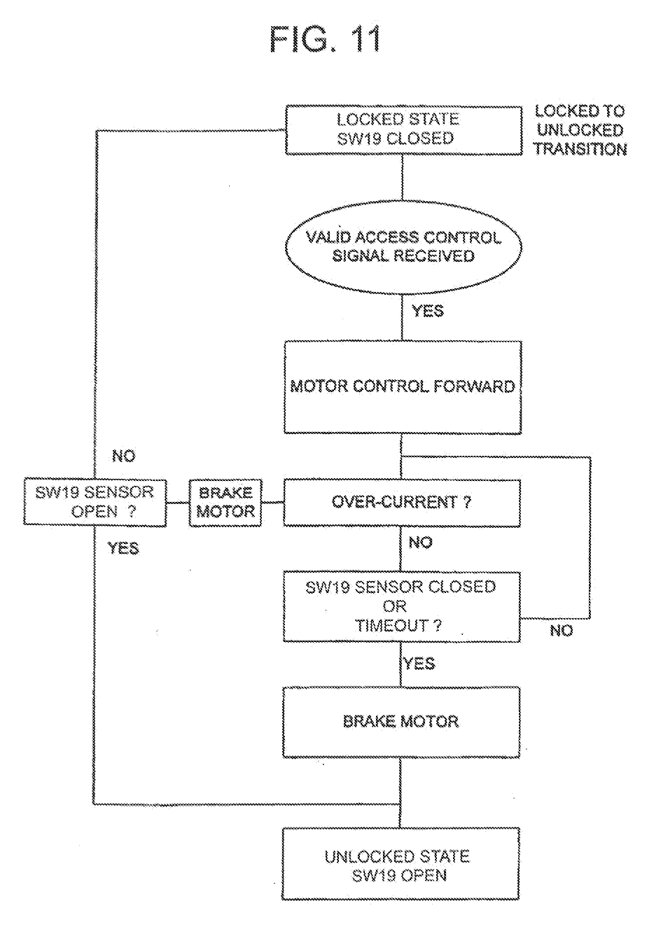

Referring to FIGS. 10A-F, there is shown various alternative cam 1 elements which can be used with the present locking system. FIG. 10B shows the same cam as in the previous FIGS. 1-9, and it is preferably used with a guide 20 as shown in FIG. 3.

FIG. 10A shows a notched element 1 with a raised lip 22 and notched 23 which would co-act with receiver 13, slot 13A for a self guidance action. It is similar to the bayonet catch action of applicants' referenced patents.

FIG. 10C shows another notched form with a notch 23C and a horizontal lip 22C. This form provides a tip 24C to guide the cam into slot 13A.

FIG. 10D shows a cam form with a single roller 25D and FIG. 10E shows a double roller 26B for smoother transitions and increased cam life in more demanding and heavy duty applications, respectively. FIG. 10F shows a shaped cam 28 that is generally conical. It will enter the receiver slot and provide pull in with the longitudinal movement of the driving unit and rotation is unnecessary to its operation. Rollers, not shown, can be carried by the receiver or the conical shaped cam to reduce wear and friction.

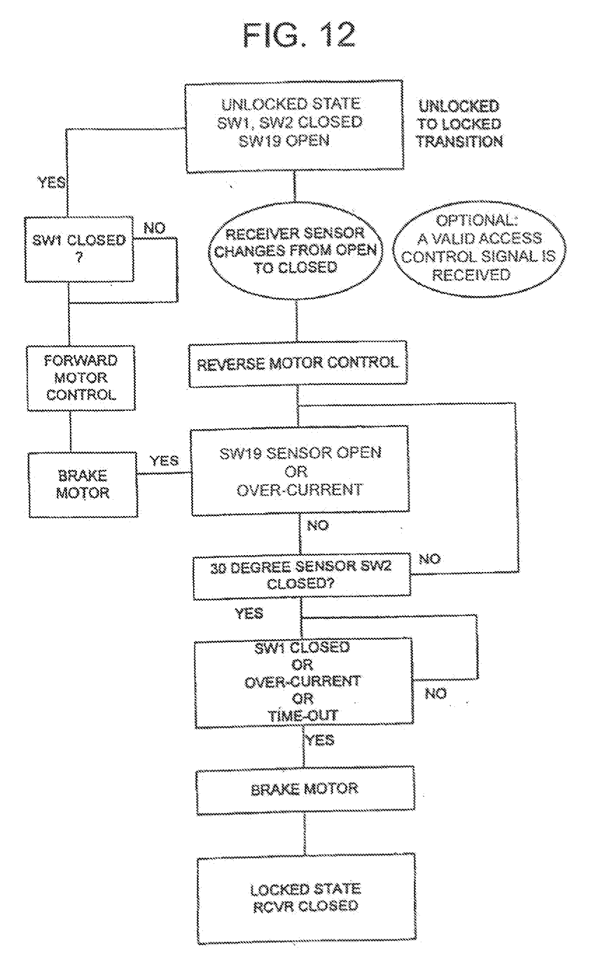

Flow charts FIG. 11 and FIG. 12, respectively indicate the lock to locked events and vice-versa for the cam locking system. The sensor switch 19 which is operated by slide 17 that determines the position and absence of the receiver 13 provides the requisite signals for the controller to operate the motor 10.

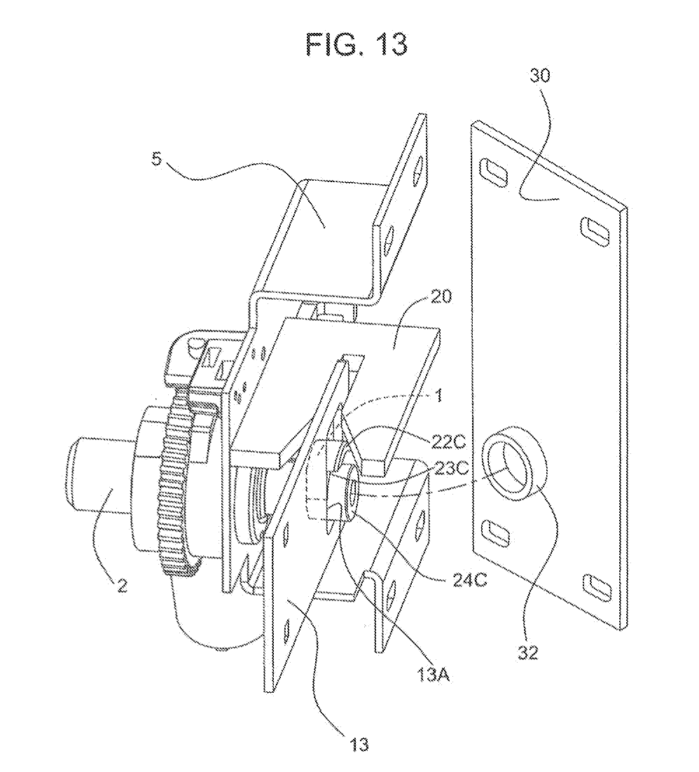

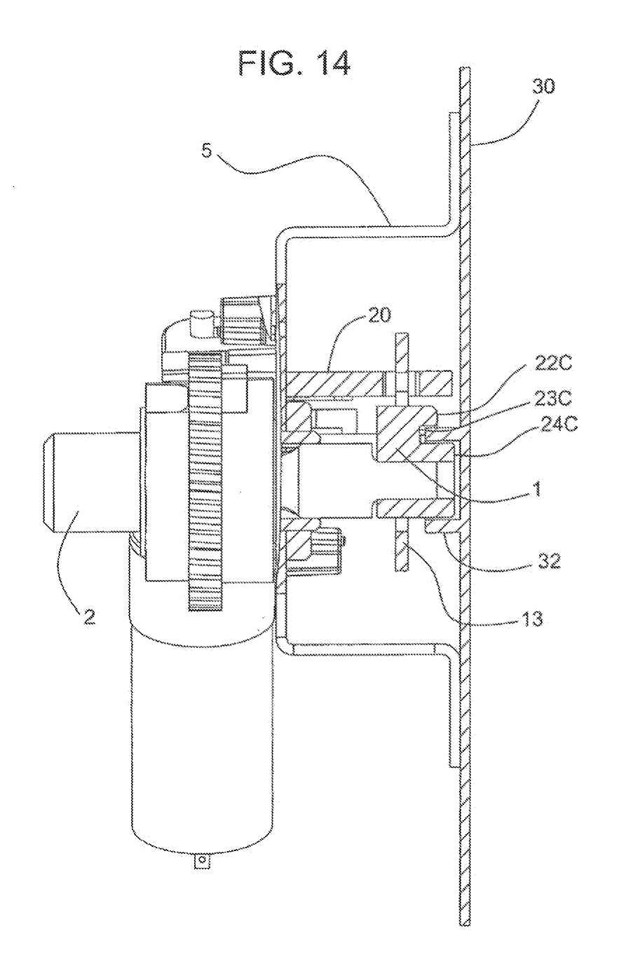

Referring to FIGS. 13 and 14 there is shown a locking system like the one discussed with respect to FIG. 3, for example, but with additional support means for the outboard end of the cam when in the extended portion. This provides additional strength against attempted prying open of the door.

In accordance with the present aspect of the invention, the cam 1 is preferably like that in FIG. 10C. A plate member 30 that can be affixed along wall bracket 5, carries a bushing means 32 into which the extended portion 24c of cam 1 fits and provides strengthened support of the cam outboard end.

As explained further herein, the present invention can be used with an axially rotatable pin with a finned end here shown on the door B in FIG. 17. The pin upon rotation when the door is closed catches one of the fins against a bracket 132 on the cabinet C. Placement of at least one of such pin and bracket arrangements prevents prying of the door at a corner. With the cam locking means adjacent an opposite corner, both door opening corners are protected.

Unlocked to Locked for the Bayonet Locking System:

In controlling the motor FIG. 18 item 110 to change the state of the lock from unlocked to locked, the controller FIG. 18 Item 108 shall wait to receive a valid lock signal from the operator. This signal shall at a minimum be a sensor signal received by the controller that the bayonet FIG. 17 Item 101 is seated in the receiver as indicated by FIG. 19 (Receiver sensor closed). It is a requirement that the controller must measure the state change of the receiver sensor FIG. 20 Item 117 from open to closed circuit in order to initiate the locking event. In addition to this signal, the controller FIG. 18 Item 108 may also expect to receive a valid access control signal from the operator simultaneously, for example the electronic key. This dual signal requirement would serve the purpose of insuring the operator will not accidentally lock the access control means in the enclosure. The controller FIG. 18 Item 108 shall proceed to energize the motor FIG. 18 Item 110 in the reverse direction. The controller FIG. 18 Item 108 will wait for a position feedback indicator FIG. 18 Item 106a (SW 1) which is measured by the controller CPU located on FIG. 18 Item 108 to determine the lock has landed in the secure state. In case the FIG. 18 Item 106a (SW 1) sensor is failed, the controller uses a motor current feedback signal to detect end of FIG. 26 area 102b end of travel by sensing a stall motor condition and to de-energize the motor. In case both sensors fail, the controller will discontinue operation based on elapsed time.

In addition to the typical locking control operation described above, several safety and fault tolerant monitoring processes must be included in the locking control algorithm. For example, when the controller proceeds to energize the motor, the bayonet will begin to turn and will proceed to be captured behind the stationary receiver device to accomplish the locking feature. At this interface, there can exist a misalignment of the bayonet to the receiver FIG. 17 item 113 and the bayonet Item 101 can jam into the receiver surface area FIG. 21 area 113a, which would cause a failure of the lock. This failure can be detected by the electronics, which would proceed with a re-initialization process of the lock components (lock bayonet and controller).

The bayonet jam detection will most likely take place during the period the bayonet is rotating to pass behind the receiver. This period is detected by the controller by monitoring a feedback sensor that measures the FIG. 18 Item 102 which relates to the bayonet position, referred to as the FIG. 18 Item 106b 30 degree sensor SW2. To properly recover from a bayonet jam event during the bayonet rotation period described above, the detection system we chose to implement is a system where the lock motor controller FIG. 18 Item 108 monitors two sensors and controls the lock motor FIG. 18 Item 110 as described below:

The bayonet receiver sensor FIG. 20 Item 117, which is open when the lock is unlocked, would produce a closed signal when the bayonet seats in the receiver to initiate the locking event. Referred to as closed but not secure. If while the FIG. 18 Item 106b (SW2) sensor is closed (less than 30 degrees rotation), the receiver later produces an open signal to the controller to indicate the bayonet is no longer properly aligned behind the receiver.

A sensor that measures the current draw of the motor turning the bayonet. If while the FIG. 18 Item 106b (SW2) sensor is closed and motor current exceeds a pre-determined value which equals the stall current value of the motor selected for the application, the controller will determine that the bayonet is jammed into the receiver, or, possibly another type of bayonet restriction exists.

The bayonet jam recovery procedure that the controller shall follow is described below:

The controller FIG. 18 Item 108 shall proceed to de-energize the motor FIG. 18 item 110 to stop the bayonet FIG. 18 Item 101 from attempting to turn.

The controller shall proceed with a forward energization of the lock motor to return the bayonet to the fully unlocked position. Once the FIG. 18 Item 106a (SW1) sensor is closed and the fully unlocked position FIG. 21 is achieved by the bayonet, the controller will brake the FIG. 18 Item 110 motor and the controller FIG. 18 Item 108 will return to the unlocked operation mode. In this mode, the controller FIG. 18 Item 108 will wait for a locking initiation signal from the operator via a state change from opened to closed by the receiver sensor. FIG. 20 Item 117.

Flow-charts FIG. 30 and FIG. 31, respectively, indicate the lock to unlocked events and vice-versa for the bayonet locking system.

In accordance with another feature of the invention, referring to FIG. 17, an axially rotatable pin 130 with a finned end 131 is here shown on the door B. The pin 130 upon rotation when the door is closed catches one of the fins 131 against a bracket 132, here shown on the cabinet C. Placement of at least one of such pin and bracket arrangements prevents prying of the door at a corner. With the bayonet locking means adjacent an opposite corner, both door opening corners are protected.

With reference to FIGS. 32-40, still another embodiment of the locking system 200 of the present invention can be understood. In this preferred embodiment, beginning with FIG. 32, the locking system 200 consists of a latching assembly 201 including a motor 202 connected to a second drive gear 203 by a first drive gear 204, a pair of mirror-image pivotable plates 210A, B, and a latching plate 211 connected to the pivotable plates 210A, B (see FIG. 40). The latching plate 211 connects to both latching plates 210A, B and is configured to engage a receiving post 212. Preferably, as shown in FIG. 40, the latching plate 211 has a U-shaped notch 213 into which the post 212 is guided and secured.

Further, attached to a surface of the second drive gear 203 is a cam element 205, the function of which is explained below. Alternatively, the cam element 205 may be connected through the gear 203 at a top surface with a second cam element 206 attached to a bottom surface of gear 203, as shown in FIG. 36. The dual cam elements divide the force applied by each can to the inner edge of the respective openings.

The cam elements 205, 206 direct the movement of the pivotable plates 210A, B by biasing against an inner edge 221 of the opening 217 on each plate 210 (see FIG. 40). The cam elements 205, 206 may be made from a rigid material, relative to the gear 203, or they may comprise a roller 218 or another element that would serve to apply a force on an inner edge 221 of the plate opening 217 at a reduced friction.

The pivotable plates 210A, B are preferably held in place by a mounting post 224 through slot 225 (FIG. 40). As illustrated in FIGS. 32-38, the plates 210A, B rotate and slide about the mounting post via slot 225 as a result of the movement of the cam elements 205 and 206. That is, as gear 203 operates in a clockwise direction (as viewed in FIGS. 32-35), cam element 205 moves into contact with the inner edge 221 of the opening 217. As a result, the pivotable plates 210A, B are pivoted about mounting post 224 to move substantially perpendicular to a longitudinal axis of the receiving post 212. As the gear 203 continues to rotate, the cam element 205 contacts a different portion of the inner edge 221 of the opening 217 and directs the pivotable plates 210A, B in a direction substantially parallel to the longitudinal axis. This movement will be referenced in more detail below.

The receiving post 212, as shown in FIG. 39, is substantially cylindrical with two recessed flat surfaces 226 and 227 on opposing sides and positioned proximate one end of the post 212. These surfaces 226, 227 are engaged by the U-shaped notch 213 in the latching plate 211 of the locking system 200. The post 212 may be round in cross-section or of any other shape, including square, polygonal, and oval. For some applications, the post 212 may include only a single recessed surface to be engaged. Preferably, the post is manufactured of a rigid material that can provide sufficient strength when engaged by the latching plate 211, whether passing under and/or behind and/or through the post 212.

A portion of the locking system 200 (e.g., the latching assembly 201) can be mounted in a door or in a cabinet, including any door jamb or frame, in any manner known to those of skill in the art. Likewise, the post 212 of the locking system 200 may be mounted in the other of the door or the cabinet, including any part of the door jamb or frame. By “cabinet” the present disclosure is meant to include a room, structure, container, box, machine, furniture, appliance, chamber, cavity, vessel, compartment, or the like, including any portion thereof, whether opened or closed, and having thereon an opening of any size or shape over which a door, panel or similar structure may be secured. Collectively, the cabinet and door may be referred to as a “unit” in this disclosure.

In a preferred embodiment, the post 212 is attached to a door (not shown) and enters an opening of the locking system 200 prior to a locking event. The locking event can be triggered by detection of the post 212 or detection of closure of the door by, for example, position switch 209. The closing of position switch 209 sends a signal to a controller 230, which initiates operation of the power train or motor 202. The motor 202 will proceed to rotate a first driving member, worm gear 204 of FIG. 33, which is coupled to turn a second driving member, gear 203 of FIG. 33.

As described above, the rotation of gear 203 functions to move cam elements 205, 206 about the gear axis. The first movement of the pivotable plates 210A, B moves the latching plate 211 to engage the receiving post 212 about the recessed surfaces 216, 217. The drive gear 203 via cam elements 205, 206 applies a force on the inner edge 221 of the opening 217. As the plates 210A, B pivot, the U-shaped notch 213 of latching plate 211 will latch onto the receiving post 212 by moving substantially latitudinal. The post 212 and the U-shaped notch 213 preferably consist of chamfered surfaces in order to guide any initial misalignment of the latch elements together properly.

Once the latching plate 211 moves latitudinal into the position of FIG. 34, the unit is latched. The motor 202 will continue to rotate and the resulting force of the gear 203 and cam elements 205, 206 on the shaped slot 225 of the pivotable plates 210A, B will move the plates in a substantially longitudinal direction to the position illustrated in FIG. 35. As the pivotable plates 210A, B move longitudinally, the engaged post 212 is drawn inward, serving to draw the door of the cabinet into the cabinet. The motor 202 will continue to turn until the controller 230 that controls the motor 202 senses the position switches 223 and discontinues operation of the motor 232 to complete the locking operation.

To unlatch and unlock the locking system 200 in a preferred embodiment, the controller 230 will accept an access control signal from, for example, a numerical keypad (not shown), and in response the controller shall initiate the motor 202 to begin to unlatch the unit. In this embodiment, the controller reverses the motor 202, turning the worm gear 204 and driving the gear 203 and cam element 205, 206. This movement occurs in an order opposite to that described above. That is, the cam elements 205, 206 serve to move and extend the pivotable plates 210A, B and thus the latching plate 211 longitudinally to allow the post 212 to retreat from its drawn in position shown in FIG. 35. The resulting position is illustrated in FIG. 34. From this position, the motor 202 continues to rotate the gear 203 and cam element 205. The force of the cam element 205 on the opening 217 of the plates 210A, B moves the latching plate 211 latitudinal to disengage the U-shaped notch 213 from the receiving post 212 to unlatch the unit as illustrated in FIG. 33 and allow opening of the door (see FIG. 32).

An advantage of the present invention is the U-shaped notch 213 in latching plate 211 which provides for two parallel engagement surfaces between the locking system 200 and the receiving post 212. Engagement at two parallel surfaces along two surfaces of the post 212 provides 1) proper alignment of the post 212 with the latching plate 211 when the latching part of the locking process takes place, 2) greater strength of the connection, compared to the use of a single engagement surface, to allow the mechanism to draw-in the post 212 with a greater force, and 3) the ability to withstand greater pull-apart forces in the event of an attempted forced-entry to the unit. Of course, the notched surfaces of the post 212 need not be parallel to each other and the U-shaped notch 213 may take another form which provides double surface engagement.

Another advantage of an embodiment of the present invention is the shape and geometry of the pivotable plates 210A, B. The plates 210A, B provide two attachment arms connecting to the drive gear 203 and cam elements 205, 206. The two attachment arms serve to divide the load onto the two plates, instead of one, and increases the strength of the locking system 200 to prevent a forced entry.

What is claimed is:

1. A locking system for locking a door to an opening in a cabinet or the like, the system comprising:
a latching assembly for attachment to one of either a door, a cabinet or the like, the latching assembly comprising:
a motor;
a first driving member operatively coupled to the motor;
a second driving member having a pivot and operatively coupled to the first driving member;
a first pivotable plate having a slidable pivot point and an opening defined therein by an interior edge;
a second pivotable plate having a slidable pivot point and an opening defined therein by an interior edge, the pivot point and the opening corresponding to and aligned with the pivot point and opening of the first pivotable plate;
a latching plate joining each of the first and second pivotable plates;
a first cam element fixed to a first surface of the second driving member about the pivot and positioned within the opening of the first pivotable plate to engage the interior edge;
a second cam element fixed to a second surface of the second driving member about the pivot and positioned within the opening of the second pivotable plate to engage the interior edge; and
a receiving post for attachment to the other of the door or the cabinet, the receiving post comprising:
a longitudinal axis; and
a latching portion;
wherein,
the first driving member is rotated by the motor;
the second driving member is rotated by the first driving member;
the first and second cam elements move with the second driving member to bias against the interior edge of the respective openings of the first and second pivotable plates;
the first and second pivotable plates are moved by the first and second cam elements to either engage the latching plate with or disengage the latching plate from the latching portion of the receiving post; and
the receiving post is moved along an axis substantially parallel to the longitudinal axis of the post by a force applied by the latching plate to the latching portion.

2. The locking system of claim 1, further comprising a first position switch for initiating operation of the motor, the first position switch being responsive to one of either the door or the cabinet.

3. The locking system of claim 1, further comprising a second position switch for discontinuing operation of the motor, the second position switch being responsive to one of the first pivotable plate, the second pivotable plate, the first cam element, the second cam element, the door, the receiving post, or the cabinet.

4. The locking system of claim 1, wherein the first driving member comprises a worm screw.

5. The locking system of claim 1, wherein the second driving member comprises a toothed gear.

6. The locking system of claim 1, wherein the latching plate comprises a notch into which the latching portion of the receiving post is guided during locking

7. The locking system of claim 6, wherein the latching portion of the receiving post comprises a first engagement surface and a second engagement surface, the two surfaces being substantially parallel.

8. The locking system of claim 2, wherein the first position switch is attached to the cabinet and is responsive to the door.

9. The locking system of claim 1, wherein the slideable pivot point in the first pivotable plate comprises a slotted opening defined in the plate.

10. The locking system of claim 8, wherein the slideable pivot point in the second pivotable plate comprises a slotted opening defined in the plate, the slotted opening of the first pivotable plate aligning with the slotted opening of the second pivotable plate.

11. The locking system of claim 1, wherein the latching portion of the receiving post comprises a slotted opening into which the latching plate is guided during locking.

12. The locking system of claim 1, wherein the motor is reversible.

13. The locking system of claim 1, wherein the first and second pivotable plates move together in a first direction substantially perpendicular to the longitudinal axis of the receiving post and in a second direction substantially parallel to the longitudinal axis of the receiving post.

14. The locking system of claim 13, wherein movement by the first and second plates in the first direction is about a first pivot point on the plates and movement in the second direction has a second pivot point on the plates different from the first pivot point.

15. A method for locking a door to an opening, the method comprising the steps of:
operating a power train to turn a first driving member;
turning a second driving member coupled to the first driving member;
moving a latching plate fixed to first and second pivoting plates having corresponding respective slidable pivot points and openings defined thereon;
engaging a latching portion of a receiving post having a longitudinal axis with the latching plate;
continuing movement of the latching plate;
drawing the receiving post in a direction parallel to the longitudinal axis;
sensing a position of one of the first driving member, the second driving member, the latching plate, or the receiving post; and
discontinuing operation of the power train when a predetermined position is achieved;
wherein, the latching plate and the receiving post are attached to one of either a door or a cabinet having an opening.

16. The method of claim 15, further comprising the steps of:
sensing a position of the door; and
signaling a controller to initiate operation of the power train.

17. The method of claim 15, wherein the step of moving a latching plate comprises the step of rotating a first cam element about a pivot within the opening of the first pivotable plate.

18. The method of claim 17, wherein the step of moving a latching plate further comprises the step of rotating a second cam element about a pivot within the opening of the second pivotable plate.

19. The method of claim 15, wherein the step of discontinuing operation of the power train comprises the steps of:
sending a signal to a controller electronically coupled to the power train based on a sensed position of one of the first driving member, the second driving member, the latching plate, or the receiving post;
receiving the signal at the controller; and
stopping the turning of the first driving member.

20. The method of claim 15, wherein the power train is a reversible motor.

21. The method of claim 20, wherein the first driving member is a worm screw and the second driving member is a toothed-gear.

22. The method of claim 17, wherein the first cam element biases against an inner edge of the opening of the first pivotable plate.

23. The method of claim 18, wherein the second cam element biases against an inner edge of the opening of the second pivotable plate.

24. The method of claim 15, wherein the power train is reversible to unlock the door.
